(19) United States
(12) Patent Application Publication
(10) Pub. No.: US 2024/0026191 A1
(43) Pub. Date: Jan. 25, 2024

(54) STYRENE BUTADIENE RUBBER LATEX COMPOSITIONS AND METHODS FOR MAKING AND USING SAME

(71) Applicant: LION COPOLYMER HOLDINGS, LLC, Geismar, LA (US)

(72) Inventors: Lawrence Douglas HARRIS, Geismar, LA (US); Willie C. Burton, Geismar, LA (US); Hao Ding, Geismar, LA (US)

(73) Assignee: LIONEL COPLYMER HOLDINGS, LLC, Geismar, LA (US)

(21) Appl. No.: 18/374,893

(22) Filed: Sep. 29, 2023

Related U.S. Application Data
(63) Continuation-in-part of application No. 18/141,537, filed on May 1, 2023.
Application No. 18/141,537 is a continuation of application No. 17/833,870, filed on Jun. 6, 2022, now Pat. No. 11,674,059.
(60) Provisional application No. 63/208,256, filed on Jun. 8, 2021.

(51) Int. Cl. C09J 109/08; C08F 236/10

(52) U.S. Cl. CPC C09J 109/08; C08F 236/10

(57) ABSTRACT

Disclosed herein are methods for making styrene butadiene rubber latex compositions with high solids content. In an embodiment, the method includes mixing a seed, a styrene, an initiator, a base, one or more surfactants, and a solvent; adding a first portion of 1,3-butadiene to make a first reaction mixture; heating the first reaction mixture to make a first styrene butadiene rubber latex, where the first styrene butadiene rubber latex has an average Zeta potential from about −49.3 mV to about −78 mV; mixing the first styrene butadiene rubber latex, a styrene, a base, an initiator, one or more surfactants, and a solvent; adding a second portion of 1,3-butadiene to make a second reaction mixture; and heating the second reaction mixture to make a second styrene butadiene rubber latex, where the second styrene butadiene rubber latex has an average Zeta potential from about −41 mV to about −64 mV.

### CROSS-REFERENCE TO RELATED APPLICATIONS

The present patent application is a continuation-in-part of U.S. patent application Ser. No. 18/141,537 filed May 1, 2023, which is continuation of U.S. patent application Ser. No. 17/833,870 filed Jun. 6, 2022, (now U.S. Pat. No. 11,674,059), which claims benefit to U.S. Provisional Patent Application 63/208,256, filed Jun. 8, 2021, each of which is incorporated herein by reference in its entirety.

### BACKGROUND

### Field

Provided herein are butadiene rubber latex compositions and methods for making them with high solids content.

### Description of the Related Art

Styrene butadiene rubber (SBR) is a synthetic rubber derived from styrene and butadiene. Styrene butadiene rubber is used in a wide variety of products, such as adhesives, coatings, paints, and tires. The preparation of styrene butadiene rubber by emulsion polymerization has long been known. Emulsion polymerization of styrene butadiene rubber is generally categorized into hot and cold, which refers the temperature at which the polymerization occurs. Hot emulsion polymerization generally occurs at a temperature around 50-60° C., while cold emulsion polymerization generally occurs at a temperature around 5° C. The performance characteristics of the resulting styrene butadiene rubbers is dependent upon the rubber composition, particle size, and rubber morphology.

Many techniques have been tried to control these parameters to provide a styrene butadiene rubber with the desired performance characteristics. For example, U.S. Pat. Nos. 5,189,107, 4,122,136, and 3,687,923, disclose latex polymers having uniform particle size can be obtained by using latex seeds in the polymerization reaction. U.S. Pat. No. 3,562,235 discloses modifying the polymeric morphology of latex polymers in a stepwise fashion by introducing different monomers at different stages of the polymerization reaction. A three-stage step wise addition process in combination with a polystyrene seed latex is disclosed by U.S. Pat. No. 4,742,108. This patent attempts to obtain a latex having high tensile strength without loss of elongation by employing a second stage monomer feed having a higher glass transition temperature than the first and third stage monomer feeds. U.S. Pat. No. 4,515,914 attempted to prepare highly coalescence-capable and deformable latexes using a two-stage polymerization process resulting in a copolymer core and a shell of linear styrene.

The method used for synthesizing the styrene butadiene rubber is chosen based upon the desired product. For example, the styrene butadiene rubber used in tires is not effective for coatings and adhesives. For adhesive and coating applications a high solids content of styrene butadiene rubber latex is needed. Currently, high solids content latexes are obtained by removing water from low solids emulsions obtained from conventional emulsion polymerization. However, this process is energy intensive and often results in coagulation of the styrene butadiene rubber latexes, which ruins their use in many products.

Consequently, there is a need for new methods that can make styrene butadiene rubber latexes with a high solids content.

### SUMMARY

Disclosed herein are methods for making high solids styrene butadiene rubber latexes, which can be used in adhesive compositions. In a specific embodiment, the method includes: mixing a seed, a styrene, an initiator, a base, one or more surfactants, and a solvent to make a first mixture, where the first mixture has pH from about 3.0 to about 12.0; adding a first portion of 1,3-butadiene to the first mixture to make a first reaction mixture; heating the first reaction mixture to a temperature above 40° C. for a first reaction time from about 10 hours to about 24 hours to make a first styrene butadiene rubber latex, where the first styrene butadiene rubber latex has an average Zeta potential from about −49.3 mV to about −78 mV; mixing the first styrene butadiene rubber latex, a styrene, a base, an initiator, one or more surfactants, and a solvent to make a second mixture, where the second emulsion has a pH from about 4.0 to about 12.0; adding a second portion of 1,3-butadiene to the second mixture to make a second reaction mixture; and heating the second reaction mixture to a temperature above 40° C. for a second reaction time of from about 10 to about 24 hours to make a second styrene butadiene rubber latex, where the second styrene butadiene rubber latex has a solids content greater than the first styrene butadiene rubber latex, where the second styrene butadiene rubber latex has an average Zeta potential from about −41 mV to about −64 mV.

In another specific embodiment, the method includes: mixing a seed, a styrene, an initiator, a base, one or more surfactants, and a solvent to make a first mixture, where the first mixture has pH from about 3.0 to about 12.0; adding a first portion of 1,3-butadiene to the first mixture to make a first reaction mixture; heating the first reaction mixture to a temperature above 40° C. for a first reaction time from about 10 to about 24 hours to make a first styrene butadiene rubber latex, where the first styrene butadiene rubber latex has an average Zeta potential from about −49.3 mV to about −78 mV; mixing the first styrene butadiene rubber latex, a styrene, a base, an initiator, one or more surfactants, and a solvent to make a second mixture, where the second emulsion has a pH from about 3.0 to about 12.0; adding a second portion of 1,3-butadiene to the second mixture to make a second reaction mixture; and heating the second reaction mixture to a temperature above 40° C. for a second reaction time of from about 10 hours to about 24 hours to make a second styrene butadiene rubber latex, where the second styrene butadiene rubber latex has a solids content greater than the first styrene butadiene rubber latex, where the second styrene butadiene rubber latex has an average Zeta potential from about −41 mV to about −64 mV.

In another specific embodiment, a styrene butadiene rubber latex, where the styrene butadiene rubber latex has a weight ratio of styrene to butadiene from about 20 to about 30 of styrene to about 80 to about 70 of butadiene, where the styrene butadiene rubber has an average particle size from about 128 nm to about 200 nm, where the styrene butadiene rubber latex has a solids content from greater than about 45 wt %, where the styrene butadiene rubber latex has a density from about 0.999 g/mL to about 1.034 g/mL, where the styrene butadiene rubber latex has an average Zeta potential from about −41 mV to about −64 Mv, and where the styrene butadiene rubber latex has a viscosity from about 3.0 cP to about 65.5 cP.

### BRIEF DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 is a graph showing the density as a function of percent solids content for a styrene butadiene rubber latex at stage 1.

FIG. 2 shows Table 5, the properties of the styrene butadiene rubber latex for various reaction times at stage 1.

FIG. 3 is a graph showing the particle size as a function of reaction time for a styrene butadiene rubber latex at stage 1.

FIG. 4 is a graph showing the percent solids as a function of reaction time for a styrene butadiene rubber latex at stage 1.

FIG. 5 is a graph showing the particle size as a function of viscosity for a styrene butadiene rubber latex at stage 1.

FIG. 6 is a graph showing the particle size as a function of viscosity for a styrene butadiene rubber latex at stage 2.

FIG. 7 shows Table 9, the properties of the styrene butadiene rubber latex for various reaction times at Stage 1.

FIG. 8 is a graph showing the percent solids as a function of reaction time for a styrene butadiene rubber latex at stage 2.

FIG. 9 is a graph showing the particle size as a function of reaction time for a styrene butadiene rubber latex at stage 1.

FIG. 10 is a graph showing the density as a function of percent solids content for the styrene butadiene rubber latex at stage 2.

FIG. 11 is a graph showing the percent solids as a function of viscosity for a styrene butadiene rubber latex at stage 1.

FIG. 12 is a graph showing the percent solids as a function of viscosity for a styrene butadiene rubber latex at stage 2.

FIG. 13 is a graph showing the changes in particles size as a function of surfactant weight ratios used in making the styrene butadiene rubber latex.

### DETAILED DESCRIPTION

Disclosed herein are styrene butadiene rubber latexes with high solids content and methods for making them. The methods can include, but are not limited to: mixing one or more seeds, one or more styrenes, one or more initiators, one or more chain transfer agents, one or more bases, one or more acids, one or more salts, one or more surfactants, and one or more solvents to make a first mixture, adding a first portion of 1,3-butadiene to the first mixture to make a first reaction mixture; heating the first reaction mixture to a temperature for a first reaction time to make a first styrene butadiene rubber latex; mixing the first styrene butadiene rubber latex, one or more styrene, one or more base, one or more initiators, one or more surfactants, and one or more solvents to make a second mixture, adding a second portion of 1,3-butadiene to the second mixture to make a second reaction mixture; and heating the second reaction mixture to a temperature for a second reaction time to make a second styrene butadiene rubber latex, where the second styrene butadiene rubber latex has a solids which is higher than that of the first solids concentration. The method for making styrene butadiene rubber latexes can include a multi-step batch process. For example, the method for making styrene butadiene rubber latexes can include one, two, three, four, five, six, seven, eight, nine, ten, or more steps. The method for making styrene butadiene rubber latexes can include, but is not limited to, emulsion polymerization or solution polymerization. Also, the method for making styrene butadiene rubber latexes can include making the one or more seeds in an initial reaction mixture (discussed below).

The one or more seeds can include, but are not limited to: polystyrene, natural rubber, styrene-butadiene, styrene butadiene rubber, solution styrene butadiene, ethylene/alpha-olefin, nitrile rubber, polybutadiene, and mixtures thereof. The one or more seeds can be made in an initial reaction mixture before the first mixture of the method for making styrene butadiene rubber latexes or the one or more seed can be acquired commercially.

The one or more seeds can be included in the first mixture, first reaction mixture, second mixture, second reaction mixture, third mixture, third reaction mixture, and higher iterations of mixtures and reaction mixtures in a weight percent that varies widely. For example, the seeds can be included in the first mixture, first reaction mixture, second mixture, second reaction mixture, third mixture, third reaction mixture, and higher iterations of mixtures and reaction mixtures in a weight percent from a low of about 0.1 wt %, about 1 wt % or about 10 wt %, to a high of about 70 wt %, about 80 wt % or about 95 wt %. In another example, the seeds can be included in the first mixture, first reaction mixture, second mixture, second reaction mixture, third mixture, third reaction mixture, and higher iterations of mixtures and reaction mixtures in a weight percent from about 0.1 wt % to about 95 wt %, about 0.1 wt % to about 5 wt %, about 1 wt % to about 10 wt %, about 10 wt % to about 30 wt %, about 30 wt % to about 50 wt %. The one or more seeds can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more seeds can have a particle size that varies widely. For example, the seeds can have an average particle size from a low of about 5 nm, about 10 nm, or about 20 nm, to a high of about 100 nm, about 200 nm, or about 500 nm. In another example, the seeds can have an average particle size from 5 nm to about 500 nm, about 6 nm to about 10 nm, about 7 nm to about nm, about 30 nm to about 40 nm, about 20 nm to about 50 nm, about 25 nm to about 60 nm, about 30 nm to about 200 nm, about 70 nm to about 350 nm, about 100 nm to about 400 nm, or about 32 nm to about 85 nm.

The one or more seeds can be provided in an aqueous solution, latex, dispersion, or slurry. The initial reaction mixture can have a widely varying solids content. For example, the one or more seeds can have a solids content from a low of about 5 wt %, about 10 wt %, or about 30 wt %, to a high of about 70 wt %, about 80 wt %, or about 95 wt %. In another example, the one or more seeds in an aqueous slurry can have a solids content greater than about 50 wt %, about 65 wt %, or about 80 wt %. In another example, the one or more seeds can have a solids content from about 5 wt % to about 95 wt %, about 5 wt % to about 50 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 51 wt % to about 54 wt %, or about wt % to about 80 wt %. The weight percent of the solids content of the one or more seeds can be based on the total weight of the composition or based on the total weight of the one or more seeds and water.

The one or more seeds can have a viscosity that varies widely. For example, the one or more seeds can have a viscosity from a low of about 1.0 cP, about 10.0 cP, or about 100.0 cP, to a high of about 5,000 cP, to about 9,000 cP, or about 10,000 cP. In another example, the one or more seeds can have a viscosity from about 1.0 cP to about 10.0 cP, about 1.0 cP to about 500.0 cP, about 10.0 cP to about 50.0 cP, about 10.0 cP to about 100.0 cP, about 100.0 cP to about 500.0 cP, about 100.0 cP to about 7,500.0 cP, about 6,200.0 cP to about 8,500.0 cP, about 7,387.0 cP to about 7,500.0 cP, about 7,000.0 cP to about 8,000.0 cP, about 6,500.0 cP to about 8,550.0 cP, about 7,000.0 cP to about 8,000.0 cP, or about 5,000.0 cP to about 10,000.0 cP.

The 1,3-butadiene can be contacted with the one or more styrenes in the first reaction mixture, second reaction mixture, third reaction mixture, or higher iterations of reaction mixture in a weight percent that varies widely. For example, the 1,3-butadiene can be contacted with the styrene in the first reaction mixture, second reaction mixture, third reaction mixture, or higher iterations of reaction mixture in a weight percent from a low of about 5 wt %, about 10 wt % or about 20 wt %, to a high of about 70 wt %, about 80 wt % or about 95 wt %. In another example, the 1,3-butadiene can be contacted with the styrene in a weight percent from about 5 wt % to about 95 wt %, about 5 wt %, about 50 wt %, about 70 wt % to about 90 wt %, about 10 wt % to about 30 wt %, about 40 wt % to about 70 wt %. The 1,3-butadiene can be contacted with the styrene in a weight percent that can be based on the total weight to the first reaction mixture, second reaction mixture, third reaction mixture, or higher iterations of reaction mixture; based on the total weight of the 1,3-butadiene and the one or more styrenes; or based on the one or more styrenes, 1,3-butadiene, one or more seeds, one or more initiators, one or more chain transfer agents, one or more bases, one or more acids, one or more salts, one or more surfactants, and one or more solvents.

The 1,3-butadiene can be contacted with the one or more styrenes in a single portion, multiple portions, or as a continuous flow. For example, the 1,3-butadiene can be contacted with the one or more styrenes in a single portion or multiple portions to make the first reaction mixture, second reaction mixture, third reaction mixture, and higher iterations of reaction mixtures. In another example, the 1,3-butadiene can be contacted with the one or more styrenes at a flow rate to make the first reaction mixture, second reaction mixture, third reaction mixture, and higher iterations of reaction mixtures. For example, the 1,3-butadiene can be contacted with the one or more styrenes at a flow rate of about rate of about 0.1 mL/min, about 1 mL/min, about 5 mL/min, about 10 mL/min, about 15 mL/min, or about 20 mL/min.

The 1,3-butadiene can be included in the first reaction mixture, second reaction mixture, third reaction mixture, and higher iterations of reaction mixtures in a weight percent that varies widely. For example, the 1,3-butadiene can be included in the first reaction mixture, second reaction mixture, third reaction mixture, and higher iterations in a weight percent from a low of about 5 wt %, about 10 wt % or about 20 wt %, to a high of about 70 wt %, about 80 wt % or about wt %. In another example, the 1,3-butadiene can be included in the first reaction mixture, second reaction mixture, third reaction mixture, and higher iterations of reaction mixtures in a weight percent from about 5 wt % to about 95 wt %, about 5 wt % to about 80 wt %, about 70 wt % to about wt %, about 10 wt % to about 30 wt %, about 40 wt % to about 70 wt %. The 1,3-butadiene can be included in the first reaction mixture, second reaction mixture, third reaction mixture, and higher iterations of reaction mixtures in a weight percent that can be based on the total weight to the first reaction mixture, second reaction mixture, third reaction mixture, or higher iterations of reaction mixture; or based on the one or more styrenes, 1,3-butadiene, one or more seeds, one or more initiators, one or more chain transfer agents, one or more bases, one or more acids, one or more salts, one or more surfactants, and one or more solvents.

The one or more styrenes can be contacted with the 1,3-butadiene in the first reaction mixture, second reaction mixture, third reaction mixture, or higher iterations of reaction mixture in a weight percent that varies widely. For example, the one or more styrenes can be contacted with the 1,3-butadiene in the first reaction mixture, second reaction mixture, third reaction mixture, or higher iterations of reaction mixture in a weight percent from a low of about 5 wt %, about 10 wt % or about 20 wt %, to a high of about 70 wt %, about 80 wt % or about 95 wt %. In another example, the one or more styrenes can be contacted with the 1,3-butadiene in a weight percent from about 5 wt % to about 95 wt %, about 5 wt %, about 50 wt %, about 70 wt % to about 90 wt %, about 10 wt % to about 30 wt %, about 40 wt % to about 70 wt %. The one or more styrenes can be contacted with the 1,3-butadiene in a weight percent that can be based on the total weight to the first reaction mixture, second reaction mixture, third reaction mixture, or higher iterations of reaction mixture; based on the total weight of the 1,3-butadiene and the one or more styrenes; or based on the one or more styrenes, 1,3-butadiene, one or more seeds, one or more initiators, one or more chain transfer agents, one or more bases, one or more acids, one or more salts, one or more surfactants, and one or more solvents.

The one or more styrenes can be included in the first reaction mixture, second reaction mixture, third reaction mixture, and higher iterations of reaction mixtures in a weight percent that varies widely. For example, one or more styrenes can be included in the first reaction mixture, second reaction mixture, third reaction mixture, and higher iterations in a weight percent from a low of about 5 wt %, about 10 wt % or about 20 wt %, to a high of about 70 wt %, about 80 wt % or about 95 wt %. In another example, the one or more styrenes can be included in the first reaction mixture, second reaction mixture, third reaction mixture, and higher iterations of reaction mixtures in a weight percent from about 5 wt % to about 95 wt %, about 5 wt % to about 80 wt %, about 70 wt % to about 90 wt %, about 10 wt % to about 30 wt %, about 40 wt % to about 70 wt %. The 1,3-butadiene can be included in the first reaction mixture, second reaction mixture, third reaction mixture, and higher iterations of reaction mixtures in a weight percent that can be based on the total weight to the first reaction mixture, second reaction mixture, third reaction mixture, or higher iterations of reaction mixture; or based on the one or more styrenes, 1,3-butadiene, one or more seeds, one or more initiators, one or more chain transfer agents, one or more bases, one or more acids, one or more salts, one or more surfactants, and one or more solvents.

The one or more initiators can include, but are not limited to: potassium persulfate, cumene hydroperoxide, 2,2′-azobis[2-(2-imidazolin-2-yl)propane] dihydrochloride, tert-butyl hydroperoxide, di-tert-butyl peroxide, dicumyl peroxide, benzoyl peroxide, ammonium peroxodisulfate, dicyandiamide, cyclohexyl p-toluenesulfonate, (4-hydroxyphenyl)dimethylsulfonium hexafluorophosphate, diphenyl(methyl)sulfonium tetrafluoroborate, benzyl(4-hydroxyphenyl)methylsulfonium hexafluoroantimonate, (4-hydroxyphenyl)methyl(2-methylbenzyl)sulfonium hexafluoroantimonate, triphenylsulfonium nonafluoro-1-butanesulfonate, and mixtures thereof.

The one or more initiators can be included in the first mixture, first reaction mixture, second mixture, second reaction mixture, third mixture, third reaction mixture, and higher iterations of mixtures and reaction mixtures in a weight percent that varies widely. For example, the initiators can be included in the first mixture, first reaction mixture, second mixture, second reaction mixture, third mixture, third reaction mixture, and higher iterations of mixtures and reaction mixtures in a weight percent from a low of about 0.01 wt %, about 0.1 wt % or about 1 wt %, to a high of about 5 wt %, about 10 wt % or about 15 wt %. In another example, the initiators can be included in the first mixture, first reaction mixture, second mixture, second reaction mixture, third mixture, third reaction mixture, and higher iterations of mixtures and reaction mixtures in a weight percent from about 0.01 wt % to about 0.1 wt %, about 0.01 wt % to about 5 wt %, about 0.02 wt % to about 1.0 wt %, or about 0.3 wt % to about 10 wt %. The initiators can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more chain transfer agents can include, but are not limited to: alkyl mercaptan, tert-dodecyl mercaptan, carbon tetrachloride, carbon tetrabromide, bromotrichloromethane, 4-methylbenzenethiol, isooctyl 3-mercaptopropionate, pentaphenylethane, tert-nonyl mercaptan, 4,4′-thiobisbenzenethiol. The one or more chain transfer agents can include commercially available chain transfer agents, such as Sulfole-120.

The one or more chain transfer agents can be included in the first mixture, first reaction mixture, second mixture, second reaction mixture, third mixture, third reaction mixture, and higher iterations of mixtures and reaction mixtures in a weight percent that varies widely. For example, the chain transfer agents can be included in the first mixture, first reaction mixture, second mixture, second reaction mixture, third mixture, third reaction mixture, and higher iterations of mixtures and reaction mixtures in a weight percent from a low of about 0.00075 wt %, about 0.001 wt % or about 0.005 wt %, to a high of about 1.0 wt %, about 5 wt % or about 10 wt %. In another example, the chain transfer agents can be included in the first mixture, first reaction mixture, second mixture, second reaction mixture, third mixture, third reaction mixture, and higher iterations of mixtures and reaction mixtures in a weight percent from about 0.00075 wt % to about 0.001 wt %, about 0.00090 wt % to about 1 wt %, about 0.001 wt % to about 0.01 wt %, about 0.00080 wt % to about 2 wt %, about 0.01 wt % to about 2 wt %, about 1 wt % to about 2 wt %, or about 0.00075 wt % to about 5 wt %. The chain transfer agents can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more acids can include, but are not limited to, citric acid, nitric acid, hydrochloric acid, acetic acid, phosphoric acid, sodium bisulfate, monosodium dihydrogen orthophosphate, disodium hydrogen phosphate, potassium bisulfite, ammonium chloride, ammonium sulfate, and combinations thereof.

The one or more acids can be included in the first mixture, first reaction mixture, second mixture, second reaction mixture, third mixture, third reaction mixture, and higher iterations of mixtures and reaction mixtures in a weight percent that varies widely. For example, the acids can be included in the first mixture, first reaction mixture, second mixture, second reaction mixture, third mixture, third reaction mixture, and higher iterations of mixtures and reaction mixtures in a weight percent from a low of about 0.1 wt %, about 1 wt % or about 10 wt %, to a high of about 30 wt %, about 40 wt % or about 50 wt %. In another example, the acids can be included in the first mixture, first reaction mixture, second mixture, second reaction mixture, third mixture, third reaction mixture, and higher iterations of mixtures and reaction mixtures in a weight percent from about 0.1 wt % to about 60 wt %, about 0.1 wt % to about 5 wt %, about 1 wt % to about 2 wt %, about 1 wt % to about 5 wt %, about 10 wt % to about 30 wt %. The acids can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more bases can include, but are not limited to, sodium hydroxide, potassium hydroxide, monopotassium phosphate, monosodium phosphate, disodium phosphate, dipotassium phosphate, trisodium phosphate, tripotassium phosphate, sodium bicarbonate, potassium carbonate, sodium tripolyphosphate, zinc chloride sodium carbonate, hydroxide, potassium cyanide, magnesium oxychloride, sodium acetate, bismuth oxychloride sodium, potassium sulfate, and combinations thereof.

The one or more bases can be included in the first mixture, first reaction mixture, second mixture, second reaction mixture, third mixture, third reaction mixture, and higher iterations of mixtures and reaction mixtures in a weight percent that varies widely. For example, the bases can be included in the first mixture, first reaction mixture, second mixture, second reaction mixture, third mixture, third reaction mixture, and higher iterations of mixtures and reaction mixtures in a weight percent from a low of about 0.005 wt %, about 0.01 wt % or about 1 wt %, to a high of about 2 wt %, about 5 wt % or about 30 wt %. In another example, the bases can be included in the first mixture, first reaction mixture, second mixture, second reaction mixture, third mixture, third reaction mixture, and higher iterations of mixtures and reaction mixtures in a weight percent from about 0.005 wt % to about 0.01 wt %, about 0.005 wt % to about 0.1 wt %, about 0.01 wt % to about 1 wt %, about 1 wt % to about 5 wt %, about 10 wt % to about 30 wt %. The bases can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more salts can include, but are not limited to, calcium chloride, sodium bisulfate, sodium carbonate, sodium hydrogen sulfate, sodium chloride, potassium chloride, potassium chlorate, calcium phosphate, potassium perchlorate, and combinations thereof.

The one or more salts can be included in the first mixture, first reaction mixture, second mixture, second reaction mixture, third mixture, third reaction mixture, and higher iterations of mixtures and reaction mixtures in a weight percent that varies widely. For example, the salts can be included in the first mixture, first reaction mixture, second mixture, second reaction mixture, third mixture, third reaction mixture, and higher iterations of mixtures and reaction mixtures in a weight percent from a low of about 0.1 wt %, about 0.5 wt % or about 1 wt %, to a high of about 3 wt %, 5 wt %. or about 20 wt %. In another example, the salts can be included in the first mixture, first reaction mixture, second mixture, second reaction mixture, third mixture, third reaction mixture, and higher iterations of mixtures and reaction mixtures in a weight percent from about 0.2 wt % to about 0.5 wt %, about 0.1 wt % to about 3 wt %, about 0.1 wt % to about 2 wt %, about 1 wt % to about 5 wt %, about 10 wt % to about 30 wt %. The salts can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more surfactants can include, but are not limited to: alkyldiphenyloxide disulfonate; benzene, 1,1′-oxybis-tetrapropylene sulfonate; sodium 4-(4-dodecoxysulfonylphenoxy)benzenesulfonate; alkyl mercaptan; ethoxylated amines; ethoxylated long-chain alcohols; polyglucosides; alkyl ammonium bromides; alkyl sulfonates; alkoxylated sulfates; alkyl ether sulfates; alkyl ester sulfonates; alpha olefin sulfonates; linear alkyl benzene sulfonates; branched alkyl benzene sulfonates; linear dodecylbenzene sulfonates; branched dodecylbenzene sulfonates; alkyl benzene sulfonic acids; dodecylbenzene sulfonic acid; sulfosuccinates; ethoxylated sulfated alcohols; alcohol sulfonates; ethoxylated alcohol sulfonates; propoxylated alcohol sulfonates; alcohol ether sulfates; ethoxylated alcohol ether sulfates; propoxylated alcohol sulfonates; sodium xylene sulfonate; sodium dodecyl diphenyl ether disulfonate; sulfated nonyl phenols; ethoxylated sulfated nonyl phenols; propoxylated sulfated nonyl phenols; sulfated octyl phenols; ethoxylated sulfated octyl phenols; propoxylated sulfated octyl phenols; sulfated dodecyl phenols; ethoxylated sulfated dodecyl phenols hydroxysultaines; propoxylated sulfated dodecyl phenols hydroxysultaines; ethoxylated dodecanol; alkyl ammonium bromides; cetyl trimethyl ammonium bromide; methyl sulfonate; heptyl sulfonate; decylbenzene sulfonate; dodecylbenzene sulfonate; cocoamidopropyl hydroxysultaine; lauramidopropyl hydroxysultaine; lauryl hydroxysultaine; and combinations thereof. The one or more surfactants can be anionic, cationic, zwitterionic, amphoteric, or non-ionic. Surfactants can include commercially available surfactants. Commercially available surfactants can include, but are not limited to: DOWFAX™ 2A1 by The Dow Chemical Company (2211 H.H. Dow Way Midland, MI 48674); HeiQ® SB-61 by HeiQ ChemTex Inc. (P.O. Box 5228, Concord, NC 28027); and mixtures thereof.

If two or more surfactants are present, then the two or more surfactants can have weight ratios that vary widely. For example, if two surfactants are present, they can have a weight ratio of a formula: A wt %/(A wt %+B wt %): B wt %/(A wt %+B wt %). In another example, if three surfactants are present, they can have a weight ratio of a formula: A wt %/(A wt %+B wt %+C wt %): B wt %/(A wt %+B wt %+C wt %): C wt %/(A wt %+B wt %+C wt %). In one or more embodiment, using two or more surfactants can vary the average particles size of the styrene butadiene rubber latex.

The one or more surfactants can be included in the first mixture, first reaction mixture, second mixture, second reaction mixture, third mixture, third reaction mixture, and higher iterations of mixtures and reaction mixtures in a weight percent that varies widely. For example, the surfactants can be included in the first mixture, first reaction mixture, second mixture, second reaction mixture, third mixture, third reaction mixture, and higher iterations of mixtures and reaction mixtures in a weight percent from a low of about 0.004 wt %, about 0.01 wt % or about 1 wt %, to a high of about 0.05 wt %, about 1 wt % or about 30 wt %. In another example, the surfactants can be included in the first mixture, first reaction mixture, second mixture, second reaction mixture, third mixture, third reaction mixture, and higher iterations of mixtures and reaction mixtures in a weight percent from about 0.004 wt % to about 0.03 wt %, about 0.004 wt % to about 0.01 wt %, about 0.005 wt % to about 1 wt %, about 0.1 wt % to about 2 wt %, about 0.1 wt % to about 30 wt %. The surfactants can be included in the first mixture, first reaction mixture, second mixture, second reaction mixture, third mixture, third reaction mixture, and higher iterations of mixtures and reaction mixtures in a weight percent that can be based on the total weight to the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The one or more solvents for the first mixture, first reaction mixture, second mixture, second reaction mixture, third mixture, third reaction mixture, and higher iterations of mixtures and reaction mixtures can include, but are not limited to, water, deionized water, methanol, ethanol, propanol, isopropanol, acetone, benzene, acetonitrile, chloroform, diethyl ether, methylene chloride, dimethyl formamide, ethylene glycol, propylene glycol, triethylamine, tetrahydrofuran, and combinations thereof.

The one or more solvents can be included in the first mixture, first reaction mixture, second mixture, second reaction mixture, third mixture, third reaction mixture, and higher iterations of mixtures and reaction mixtures in a weight percent that varies widely. For example, the solvents can be included in the first mixture, first reaction mixture, second mixture, second reaction mixture, third mixture, third reaction mixture, and higher iterations of mixtures and reaction mixtures in a weight percent from a low of about 5 wt %, about 10 wt % or about 20 wt %, to a high of about 70 wt %, about 80 wt % or about 95 wt %. In another example, the solvents can be included in the first mixture, first reaction mixture, second mixture, second reaction mixture, third mixture, third reaction mixture, and higher iterations of mixtures and reaction mixtures in a weight percent from about 6 wt % to about 12 wt %, about 5 wt % to about 95 wt %, about 5 wt % to about 15 wt %, about 7 wt % to about 30 wt %, about 8 wt % to about 70 wt %. The solvents can be included in the first mixture, first reaction mixture, second mixture, second reaction mixture, third mixture, third reaction mixture, and higher iterations of mixtures and reaction mixtures in a weight percent that can be based on the total weight of the first reaction mixture, second reaction mixture, third reaction mixture, or higher iterations of reaction mixture; based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The first mixture, first reaction mixture, second mixture, second reaction mixture, third mixture, third reaction mixture, and higher iterations of mixtures and reaction mixtures can be reacted and/or stirred in an open container or a closed container. The first mixture, first reaction mixture, second mixture, second reaction mixture, third mixture, third reaction mixture, and higher iterations of mixtures and reaction mixtures can be reacted and/or stirred under a vacuum. The first mixture, first reaction mixture, second mixture, second reaction mixture, third mixture, third reaction mixture, and higher iterations of mixtures and reaction mixtures can be reacted and/or stirred under an inert atmosphere, such as He, Ne, Ar, N₂, and Ar.

In an embodiment, the reaction occurs in a pressure reactor. The first mixture, first reaction mixture, second mixture, second reaction mixture, third mixture, third reaction mixture, and higher iterations of mixtures and reaction mixtures can be reacted and/or stirred under a widely varying gauge pressure. For example, first mixture, first reaction mixture, second mixture, second reaction mixture, third mixture, third reaction mixture, and higher iterations of mixtures and reaction mixtures can be reacted and/or stirred under a gauge pressure from a low of about 0.1 psig, about 1 psig, or about 5 psig, to a high of about 50 psig, about 90 psig, or about 150 psig. In another example, first mixture, first reaction mixture, second mixture, second reaction mixture, third mixture, third reaction mixture, and higher iterations of mixtures and reaction mixtures can be reacted and/or stirred under a gauge pressure from about 30 psig to about 85 psig, about 0.1 psig to about 90 psig, about 0.1 psig to about 1 psig, about 1 psig to about 85 psig, about 20 psig to about 90 psig, about 5 psig to about 20 psig, about 25 psig to about 75 psig, or about 0.1 psig to about 150 psig.

The first mixture, first reaction mixture, second mixture, second reaction mixture, third mixture, third reaction mixture, and higher iterations of mixtures and reaction mixtures can be agitated and/or stirred. For example, the mixtures and reaction mixtures can be stirred from about 50 revolution per minute (rpm) to about 1,500 rpm, about 50 rpm to about 500 rpm or about 60 rpm to about 1,000 rpm.

The first mixture, first reaction mixture, second mixture, second reaction mixture, third mixture, third reaction mixture, and higher iterations of mixtures and reaction mixtures can have a viscosity varies widely. For example, the first, second, third, and higher iterations of styrene butadiene rubber latexes can have a viscosity from a low of about 1.0 cP, about 10.0 cP, or about 100.0 cP, to a high of about 5,000.0 cP, to about 9,000.0 cP, or about 10,000.0 cP. In another example, the first, second, third, and higher iterations of styrene butadiene rubber latexes can have a viscosity from about 1.0 cP to about 10.0 cP, about 1.0 cP to about 500.0 cP, about 10.0 cP to about 50.0 cP, about 10.0 cP to about 100.0 cP, about 100.0 cP to about 500.0 cP, about 6,200.0 cP to about 8,500.0 cP, about 7,387.0 cP to about 7,500.0 cP, about 7,000.0 cP to about 8,000.0 cP, about 6,500.0 cP to about 8,550.0 cP, about 7,000.0 cP to about 8,000.0 cP, or about 5,000.0 cP to about 10,000.0 cP.

The pH of the first mixture, first reaction mixture, second mixture, second reaction mixture, third mixture, third reaction mixture, and higher iterations of mixtures and reaction mixtures can vary widely. For example, the first mixture, first reaction mixture, second mixture, second reaction mixture, third mixture, third reaction mixture, and higher iterations of mixtures and reaction mixtures can have a pH from a low of about 1.0, about 2.0, or about 3.0, to a high of about 12, about 13, or about 14. In another example, the first mixture, first reaction mixture, second mixture, second reaction mixture, third mixture, third reaction mixture, and higher iterations of mixtures and reaction mixtures can have a pH from about 3.0 to about 11.0, about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

The first mixture, first reaction mixture, second mixture, second reaction mixture, third mixture, third reaction mixture, and higher iterations of mixtures and reaction mixtures can be heated to a temperature from a low of about 0° C., about 15° C., and about 25° C., to a high of about 35° C., about 65° C., and about 200° C. For example, the first mixture, first reaction mixture, second mixture, second reaction mixture, third mixture, third reaction mixture, and higher iterations of mixtures and reaction mixtures can be heated to a temperature from about 25° C. to about 28° C., about 25° C. to about 35° C., about 25° C. to about 90° C., about 30° C. to about 45° C., about 40° C. to about 90° C., about 43° C. to about 78° C., about 40° C. to about 90° C., about 100° C. to about 200° C. In another example, the first mixture, first reaction mixture, second mixture, second reaction mixture, third mixture, third reaction mixture, and higher iterations of mixtures and reaction mixtures can be at room temperature. In another example, the reaction occurs at a temperature of greater than about 40° C. or greater than about 50° C. The first reaction mixture, second reaction mixture, third reaction mixture, and higher iterations and reaction mixtures can be performed at different temperatures. The method for making styrene butadiene rubber latexes can occur at different temperatures than the method of making the one or more seeds.

The first mixture, first reaction mixture, second mixture, second reaction mixture, third mixture, third reaction mixture, and higher iterations of mixtures and reaction mixtures can be reacted and/or stirred for a first reaction time, second reaction time, third reaction time, and higher iterations of reaction times from a short of about 15 s, about 120 s, or about 300 s, to a long of about 1 h, about 24 h, or about 72 h. For example, the first mixture, first reaction mixture, second mixture, second reaction mixture, third mixture, third reaction mixture, and higher iterations of mixtures and reaction mixtures can be reacted and/or stirred for a first reaction time, second reaction time, third reaction time, and higher iterations of reaction times can be from about 1 min to about 15 min, about 5 min to about 45 min, about to about, about 1 h to about 12 h, about 5 h to about 15 h, about 10 hours to about 24 hours, about 12 h to about 17 h, about 12 h to about 24 h, about 22 h to about 50 h, or about 24 h to about 72 h.

The first, second, third, and higher iterations of styrene butadiene rubber latexes can have a styrene content that varies widely. For example, the first, second, third, and higher iterations of styrene butadiene rubber latexes can have a styrene content from a low of about 1.0 wt %, about 5 wt %, or about 30 wt %, to a high of about 70 wt %, about 80 wt %, or about 99.0 wt %. In another example, the first, second, third, and higher iterations of styrene butadiene rubber latexes can have a styrene content of at least 75 wt %, at least 50 wt %, or at least 25 wt %. In another example, the first, second, third, and higher iterations of styrene butadiene rubber latexes can have a styrene content from about 1.0 wt % to about 99.0 wt %, about 5 wt % to about 95 wt %, about 20 wt % to about 30 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 70 wt % to about 90 wt %, about 20 wt % to 30 wt %, about 50 wt % to about 60 wt %, or about 70 wt % to about 80 wt %. The weight percent of the styrene in the styrene butadiene rubber latexes can be based on the total weight composition; based on the total weight of the one or more styrenes and 1,3-butadiene; or based on the total based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The first, second, third, and higher iterations of styrene butadiene rubber latexes can have a styrene content that varies widely. For example, the first, second, third, and higher iterations of styrene butadiene rubber latexes can have a 1,3-butadiene content from a low of about 1.0 wt %, about 5 wt %, or about 30 wt %, to a high of about 70 wt %, about 80 wt %, or about 99.0 wt %. In another example, the first, second, third, and higher iterations of styrene butadiene rubber latexes can have a 1,3-butadiene content of at least 75 wt %, at least 50 wt %, or at least 25 wt %. In another example, the first, second, third, and higher iterations of styrene butadiene rubber latexes can have a 1,3-butadiene content from about 1.0 wt % to about 99.0 wt %, about 5 wt % to about 95 wt %, about 20 wt % to about 30 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 70 wt % to about 90 wt %, about 20 wt % to 30 wt %, about 50 wt % to about 60 wt %, or about 70 wt % to about 80 wt %. In another example, the one or more styrene butadiene rubber latexes can have a weight ratio of a formula: 1,3-butadiene wt %/(1,3-butadiene wt %+styrene wt %): styrene wt %/(1,3-butadiene wt %+styrene wt %). The weight percent of the 1,3-butadiene in the styrene butadiene rubber latexes can be based on the total weight composition; based on the total weight of the one or more styrenes and 1,3-butadiene; or based on the total based on the one or more styrenes, one or more seeds, one or more initiators, one or more chain transfer agents, one or more bases, one or more acids, one or more salts, one or more surfactants, and one or more solvents; or based on the one or more styrenes, 1,3-butadiene, one or more seeds, one or more initiators, one or more chain transfer agents, one or more bases, one or more acids, one or more salts, one or more surfactants, and one or more solvents.

The first, second, third, and higher iterations of styrene butadiene rubber latexes can have a styrene butadiene rubber with a weight-average molecular weight (Mw) that varies widely. For example, the first, second, third, and higher iterations of styrene butadiene rubber latexes can have a styrene butadiene rubber with a weight-average molecular weight from a low of about 50,000 g/mol, about 60,000 g/mol, or about 70,000 g/mol, to a high of about 700,000 g/mol, about 800,000 g/mol, or about 900,000 g/mol. In another example, the first, second, third, and higher iterations of styrene butadiene rubber latexes can have a styrene butadiene rubber with a weight-average molecular weight from about 50,000 g/mol to about 900,000 g/mol, about 50,000 g/mol to about 700,000 g/mol, about 55,000 g/mol to about 850,000 g/mol, about 60,000 g/mol to about 800,000 g/mol, about 100,000 g/mol to about 700,000 g/mol, about 170,000 g/mol to about 535,000 g/mol, about 76,941 g/mol to about 803,904 g/mol, about 250,000 g/mol to about 535,000 g/mol, or about 70,000 g/mol to about 660,000 g/mol.

The first, second, third, and higher iterations of styrene butadiene rubber latexes can have a styrene butadiene rubber with an average particle size that varies widely. For example, the first, second, third, and higher iterations of styrene butadiene rubber latexes can have a styrene butadiene rubber with an average particle size from a low of about 15 nanometers (nm), about 25 nm, or about 40 nm, to a high of about 100 nm, about 200 nm, or about 500 nm. In another example, the first, second, third, and higher iterations of styrene butadiene rubber latexes can have a styrene butadiene rubber can have an average particle size from 15 nm to about 500 nm, about 25 nm to about 500 nm, about 20 nm to about 50 nm, about 25 nm to about 60 nm, about 30 nm to about 200 nm, about 40 nm to about 250 nm, about 70 nm to about 350 nm, about 100 nm to about 400 nm, about 107 nm to about 151 nm, about 100 nm to about 250 nm, about 128 nm to about 200 nm, or about 132 nm to about 500 nm. In another example, the first, second, third, and higher iterations of styrene butadiene rubber latexes can have a styrene butadiene rubber with an average length and/or diameter from a low about 50 nm, about 60 nm, or about 80 nm, to a high of about 140 μm, about 150 μm, or about 500 μm. In another example, the first, second, third, and higher iterations of styrene butadiene rubber latexes can have a length and/or diameter from about 50 nm to about 200 μm, about 50 nm to about 500 μm, about 50 nm to about 100 nm, about 60 nm to about 500 nm, about 60 nm to about 10 μm, about 65 nm to about 20 μm, about 70 nm to about 110 nm, about 75 nm to about 120 nm, about 80 nm to about 150 nm, about 80 nm to about 150 μm, about 80 nm to about 200 μm, about 100 nm to about 180 μm, about 90 μm to about 170 μm, about 100 μm to about 180 μm, about 120 μm to about 220 μm, about 150 μm to about 250 μm, or about 200 μm to about 500 μm. In another example, the first, second, third, and higher iterations of styrene butadiene rubber latexes can have a length and/or diameter greater than about 150 μm, greater than about 200 μm, or greater than about 250 μm.

The first, second, third, and higher iterations of styrene butadiene rubber latexes can have average Zeta potential (ζ-potential) value that varies widely. For example, the first, second, third, and higher iterations of styrene butadiene rubber latexes can have an average Zeta potential from a low of about −150 mV, about −100 mV, or about −75 mV, to a high of about 75 mV, about 100 mV, or about 150 mV. In another example, the first, second, third, and higher iterations of styrene butadiene rubber latexes can have an average zeta potential from about −150 mV to about 150 mV, about −80 mV to about −30 mV, about −80 mV to about 0 mV, about −80 mV to about 80 mV, about −50 mV to about 0 mV, about −50 mV to about 50 mV, about −49.3 mV to about −78 mV, about −41 mV to about −64 mV, about −25 mV to about 25 mV, about 0 mV to about 25 mV, about 0 mV to about 50 mV, or about 0 mV to about 80 mV.

The first, second, third, and higher iterations of styrene butadiene rubber latexes can be provided in an aqueous solution, latex, dispersion, or slurry. The first, second, third, and higher iterations of styrene butadiene rubber latexes can have a widely varying solids content. For example, the first, second, third, and higher iterations of styrene butadiene rubber latexes can have a solids content from a low of about 5 wt %, about 10 wt %, or about 30 wt %, to a high of about 70 wt %, about 80 wt %, or about 95 wt %. In another example, the first, second, third, and higher iterations of styrene butadiene rubber latexes in an aqueous slurry can have a solids content greater than about 45 wt %, about 50 wt %, about 65 wt %, or about 80 wt %. In another example, the first, second, third, and higher iterations of styrene butadiene rubber latexes can have a solids content from about 5 wt % to about 95 wt %, about 20 wt % to about 70 wt %, about 30 wt % to about 51 wt %, about 40 wt % to about 60 wt %, about 45 wt % to about 55 wt %, about 47 wt % to about 54 wt %, about 30 wt % to about 54 wt %, about 33 wt % to about 48 wt %, about 47 wt % to about 57 wt %, about 51 wt % to about 54 wt %, about 55 wt % to about 65 wt %, about 50 wt % to about 60 wt %, or about 50 wt % to about 80 wt %. The weight percent of the solids content of the first, second, third, and higher iterations of styrene butadiene rubber latexes can be based on the total weight of the composition or based on the total weight of the first, second, third, and higher iterations of styrene butadiene rubber latexes, and water. The method of making the styrene butadiene rubber latexes can include iterations of the reactions until the desired solids content is achieved. For example, iterating the method steps, as needed, to form a styrene butadiene rubber latex with over 50 wt % solids content.

The first, second, third, and higher iterations of styrene butadiene rubber latexes can have a viscosity that varies widely. For example, the first, second, third, and higher iterations of styrene butadiene rubber latexes can have a viscosity from a low of about 1.0 cP, about 100.0 cP, or about 100.0 cP, to a high of about 5,000.0 cP, to about 9,000.0 cP, or about 10,000.0 cP. In another example, the first, second, third, and higher iterations of styrene butadiene rubber latexes can have a viscosity from about 1.0 cP to about 10.0 cP, about 1.0 cP to about 500.0 cP, about 10.0 cP to about 50.0 cP, about 10.0 cP to about 100.0 cP, about 100.0 cP to about 500.0 cP, about 4000.0 cP to about 7,000.0 cP, about 400.0 cP to 10,000.0 cP, about 6,200.0 cP to about 8,500.0 cP, about 7,387.0 cP to about 7,500.0 cP, about 7,000.0 cP to about 8,000.0 cP, about 6,500.0 cP to about 8,550.0 cP, about 7,000.0 cP to about 8,000.0 cP, or about 5,000.0 cP to about 10,000.0 cP. In an embodiment, the one or more styrene butadiene rubbers can be a solid.

The first, second, third, and higher iterations of styrene butadiene rubber latexes can have a density that varies widely. For example, the first, second, third, and higher iterations of styrene butadiene rubber latexes can have a density from a low of about 0.800 g/mL, about 0.900 g/mL, or about 1.000 g/mL, to a high of about 1.1000 g/mL, to about 1.200 g/mL, or about 2.000 g/mL. In another example, the first, second, third, and higher iterations of styrene butadiene rubber latexes can have a viscosity from about 0.800 g/mL to about 2.000 g/mL, about 0.998 g/mL to about 1.025 g/mL, about 0.999 g/mL to about 1.034 g/mL, about 0.900 g/mL to about 1.000 g/mL, about 0.900 g/mL to about 1.100 g/mL, about 0.950 g/mL to about 1.098 g/mL, about 0.958 g/mL to about 1.500 g/mL, about 0.998 g/mL to 2.000 g/mL, or about 1.000 g/mL to about 2.000 g/mL. In an embodiment, the one or more styrene butadiene rubbers can be a solid.

The method for making styrene butadiene rubber latexes can further include a method for making the one or more seeds. The method for making the one or more seeds can include, but is not limited to: mixing one or more monomers, one or more initiators, one or more chain transfer agents, one or more bases, one or more acids, one or more salts, one or more surfactants, and one or more solvents to make an initial reaction mixture; heating the initial reaction mixture to a temperature from about to about for a first reaction time of about to about to make a seed. The method for making the one or more seeds can include, but is not limited to, emulsion polymerization or solution polymerization.

The one or more monomers can include, but are not limited to: ethylene, propylene, 1-butene, 2-butene, isobutene, 1-pentene, 2-methyl-2-butene, 1-hexene, 4-methyl-1-pentene, 3,3-dimethyl-1-butene, 2,4,4-trimethyl-1-pentene, 6-ethyl-1-hexene, 1-heptene, 1-octene, 1-decene, 1-dodecene, allene, butadiene, isoprene, chloroprene, 1,5-hexadiene, 1,3,5-hexatriene, divinylacetylene, cyclopentadiene, dicyclopentadiene, norbornene, norbornadiene, methylnorbornene, cyclohexene, styrene, alpha-chlorostyrene, alpha-methylstyrene, allylbenzene, phenylacetylene, 1-phenyl-1,3-butadiene, vinylnaphthalene, 4-methylstyrene, 4-methoxy-3-methylstyrene, 4-chlorostyrene, 3,4-dimethylalphamethylstyrene, 3-bromo-4-methyl-alphamethylstyrene, 2,5-dichlorostyrene, 4-fluorostyrene, 3-iodostyrene, 4-cyanostyrene, 4-vinylbenzoic acid, 4-acetoxystyrene, 4-vinyl benzyl alcohol, 3-hydroxystyrene, 1,4-dihydroxystyrene, 3-nitrostyrene, 2-aminostyrene, 4-N,N-dimethylaminostyrene, 4-phenylstyrene, 4-chloro-1-vinylnaphthalene, acrylic acid, methacrylic acid, acrolein, methacrolein, acrylonitrile, methacrylonitrile, acrylamide, methacrylamide, methyl acrylate, methyl methacrylate, norbornenyl acrylate, norbornyl diacrylate, 2-hydroxyethyl acrylate, 2-phenoxyethyl acrylate, trimethoxysilyloxpypropyl acrylate, dicyclopentenyl acrylate, cyclohexyl acrylate, 2-tolyloxyethyl acrylate, N,N-dimethylacrylamide, isopropyl methacrylate, ethyl acrylate, methyl alphachloroacrylate, beta-dimethylaminoethyl methacrylate, N-methyl methacrylamide, ethyl methacrylate, 2-ethylhexyl acrylate, neopentyl glycol diacrylate, cyclohexyl methacrylate, hexyl methacrylate, 2-methylcyclohexyl methacrylate, beta-bromoethyl methacrylate, benzyl methacrylate, phenyl methacrylate, neopentyl methacrylate, butyl methacrylate, chloroacrylic acid, methyl chloroacrylic acid, hexyl acrylate, dodecyl acrylate, 3-methyl-1-butyl acrylate, 2-ethoxyethyl acrylate, phenyl acrylate, butoxyethoxyethyl acrylate, 2-methoxyethyl acrylate, isodecyl acrylate, pentaerythritol triacrylate, methoxy poly(ethyleneoxy)₁₂ acrylate, tridecoxy poly(ethyleneoxy) acrylate, chloroacrylonitrile, dichloroisopropyl acrylate, ethacrylonitrile, N-phenyl acrylamide, N,N-diethylacrylamide, N-cyclohexyl acrylamide, vinyl chloride, vinylidene chloride, vinylidene cyanide, vinyl fluoride, vinylidene fluoride, trichloroethane, vinyl acetate, vinyl propionate, vinyl butyrate, vinyl benzoate, vinyl butyral, vinyl chloroacetate, isopropenyl acetate, vinyl formate, vinyl methoxyacetate, vinyl caproate, vinyl oleate, vinyl adipate, methyl vinyl ketone, methyl isopropenyl ketone, methyl alpha-chlorovinyl ketone, ethyl vinyl ketone, hydroxymethyl vinyl ketone, chloromethyl vinyl ketone, allilydene diacetate, methyl vinyl ether, isopropyl vinyl ether, butyl vinyl ethers, 2-ethylhexyl vinyl ether, 2-methoxyethyl vinyl ether, 2-chloroethyl vinyl ether, methoxyethoxy ethyl vinyl ether, hydroxyethyl vinyl ether, aminoethyl vinyl ether, alpha-methylvinyl methyl ether, divinyl ether, divinylether of ethylene glycol or diethylene glycol or triethanolamine cyclohexyl vinyl ether, benzyl vinyl ether, phenethyl vinyl ether, cresyl vinyl ether, hydroxyphenyl vinyl ether, chlorophenyl vinyl ether, naphthyl vinyl ether, dimethyl maleate, diethyl maleate, di(2-ethylhexyl)maleate, maleic anhydride, dimethyl fumarate, dipropyl fumarate, diamyl fumarate, vinyl ethyl sulfide, divinyl sulfide, vinyl p-tolyl sulfide, divinyl sulfone, vinyl ethyl sulfone, vinyl ethyl sulfoxide, vinyl sulfonic acid, sodium vinyl sulfonate, vinyl sulfonamide, vinyl benzamide, vinyl pyridine, N-vinyl pyrollidone, N-vinyl carbazole, N(vinyl benzyl)-pyrrolidine, N-(vinyl benzyl)piperidine, 1-vinyl pyrene, 2-isopropenyl furan, 2-vinyl dibenzofuran, 2-methyl-5-vinyl pyridine, 3-isopropenyl pyridine, 2-vinyl piperidine, 2-vinyl quinoline, 2-vinyl benzoxazole, 4-methyl-5-vinyl thiazole, vinyl thiophene, 2-isopropenyl thiophene, indene, coumarone, 1-chloroethyl vinyl sulfide, vinyl 2-ethoxyethyl sulfide, vinyl phenyl sulfide, vinyl 2-naphthyl sulfide, allyl mercaptan, divinyl sulfoxide, vinyl phenyl sulfoxide, vinyl chlorophenyl sulfoxide, methyl vinyl sulfonate, vinyl sulfoanilide and, mixtures thereof.

The one or more monomers can be included in the first reaction mixture, second reaction mixture, third reaction mixture, and higher iterations of reaction mixtures in a weight percent that varies widely. For example, the one or more monomers can be included in the first reaction mixture, second reaction mixture, third reaction mixture, and higher iterations in a weight percent from a low of about 5 wt %, about 10 wt % or about 20 wt %, to a high of about 70 wt %, about 80 wt % or about 95 wt %. In another example, the one or more monomers can be included in the first reaction mixture, second reaction mixture, third reaction mixture, and higher iterations of reaction mixtures in a weight percent from about 5 wt % to about 95 wt %, about 5 wt % to about 40 wt %, about 70 wt % to about 90 wt %, about 10 wt % to about 30 wt %, or about 40 wt % to about 70 wt %. The one or more monomers can be included in the first reaction mixture, second reaction mixture, third reaction mixture, and higher iterations of reaction mixtures in a weight percent that can be based on the total weight to the first reaction mixture, second reaction mixture, third reaction mixture, or higher iterations of reaction mixture; or based on the one or more monomers, one or more initiators, one or more chain transfer agents, one or more bases, one or more acids, one or more salts, one or more surfactants, and one or more solvents.

If two monomers are reacted together, then the two monomers can be contacted together in the initial reaction mixture in a weight percent that varies widely. For example, the first monomer can be contacted with the second monomer in the initial reaction mixture in a weight percent from a low of about 5 wt %, about 10 wt % or about 20 wt %, to a high of about 70 wt %, about 80 wt % or about 95 wt %. In another example, the first monomer can be contacted with the second monomer in the initial reaction mixture in a weight percent from about 5 wt % to about 95 wt %, about 5 wt % to about 40 wt %, about 70 wt % to about 90 wt %, about 10 wt % to about 30 wt %, or about 40 wt % to about 70 wt %. The first monomer can be contacted with the second monomer in the initial reaction mixture in a weight percent that can be based on the total weight to the initial reaction mixture; based on the total weight of the first monomer and the second monomer; based on the first monomer, second monomer, one or more initiators, one or more chain transfer agents, one or more bases, one or more acids, one or more salts, one or more surfactants, and one or more solvents.

The one or more initiators, one or more chain transfer agents, one or more bases, one or more acids, one or more salts, one or more surfactants, and one or more solvents of the method for the making the one or more seeds can all be the same as the first mixture, first reaction mixture, second mixture, second reaction mixture, third mixture, third reaction mixture, and higher iterations of mixtures and reaction mixtures of the method for making the styrene butadiene rubber latexes, as described above.

The reaction conditions for the initial reaction mixture of the method for making the one or more seeds can be the same as those for the first mixture, first reaction mixture, second mixture, second reaction mixture, third mixture, third reaction mixture, and higher iterations of mixtures and reaction mixtures of the method for making the styrene butadiene rubber latexes, as described above. For example, the initial reaction mixture can have the same ranges for the concentration of components, pH, reaction temperature, reaction time, pressure, solids content, and viscosity as the first reaction mixture.

The one or more styrene-butadiene rubber latexes can be included in one or more adhesive compositions. The adhesive compositions can include, but are not limited to: one or more styrene-butadiene rubber latexes, one or more tackifier agents, one or more additives, and water.

The concentration of the one or more styrene-butadiene rubber latexes in the adhesive compositions can vary widely. For example, the adhesive compositions can have a concentration of the one or more styrene-butadiene rubber latexes from a low of about 5 wt %, about 10 wt %, or about 30 wt %, to a high of about 70 wt %, about 80 wt %, or about 95 wt %. For example, the adhesive compositions can have a concentration of the one or more styrene-butadiene rubber latexes from about 5 wt % to about 95 wt %, about 5 wt % to about 9 wt %, about 5 wt % to about 30 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the one or more styrene-butadiene rubber latexes in the adhesive compositions can be based on the total weight of the total adhesive composition; based on the total weight of the one or more styrene-butadiene rubber latexes, one or more tackifier agents, one or more additives, and water.

The one or more tackifier agents can include, but is not limited to, a rosin ester, a hydrocarbon, rosin acid, terpene, modified terpene, coumarone-indene, or a combination thereof.

The content or concentration of the one or more tackifier agents in the adhesive compositions can vary widely. For example, the adhesive compositions can have a concentration of the tackifier agents from a low of about 0.1 wt %, about 1 wt %, or about 5 wt %, to a high of about 50 wt %, about 70 wt %, or about 90 wt %. In another example, the adhesive compositions can have a concentration of the tackifier agents of less than 10 wt %, less than 5 wt %, or less than 1 wt %. In another example, the adhesive compositions can have a concentration of the tackifier agents from about 0.1 wt % to about 90 wt %, 1 wt % to about 10 wt %, 2 wt % to about 10 wt %, about 2 wt % to about 20 wt %, about 5 wt % to about 60 wt %, about 5 wt % to about 30 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more tackifier agents in the adhesive compositions can be based on the total weight of the total adhesive composition; based on the total weight of the one or more styrene-butadiene rubbers latexes, one or more tackifier agents, one or more additives, and water.

One or more additives can include, but are not limited to, wetting agents, surfactants, pigments, opacifying agents, anti-foam agents, water, and mixtures thereof.

The content or concentration of the one or more additives in the adhesive compositions can vary widely. For example, the adhesive compositions can have a concentration of the one or more additives from a low of about 0 wt %, about 0.5 wt %, or about 1 wt %, to a high of about 50 wt %, about 60 wt %, or about 70 wt %. In another example, the adhesive compositions can have a concentration of the one or more additives of less than 5 wt %, less than 2 wt %, or less than 1 wt %. In another example, the adhesive compositions can have a concentration of the one or more additives from about 0 wt % to about 90 wt %, about 0.1 wt % to about 10 wt %, about 0.1 wt % to about 50 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more additives in the adhesive compositions can be based on the total weight of the total adhesive composition; based on the total weight of the one or more styrene-butadiene rubbers latexes, one or more tackifier agents, one or more additives, and water.

The water content or concentration of water in the adhesive compositions can vary widely. For example, the adhesive compositions can have a concentration of the water from a low of about 0 wt %, about 0.5 wt %, or about 1 wt %, to a high of about 50 wt %, about 70 wt %, or about 90 wt %. In another example, the adhesive compositions can have a concentration of the water of less than 1 wt %. In another example, the adhesive compositions can have a concentration of the water from about 0 wt % to about 90 wt %, about 0.1 wt % to about 10 wt %, about 0.1 wt % to about 50 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. In another example, the adhesive compositions can be free of water. The weight percent of the water in the adhesive compositions can be based on the total weight of the total adhesive composition or based on the total weight of the one or more styrene-butadiene rubbers latexes, one or more tackifier agents, one or more additives, and water.

The adhesive compositions can have a widely varying solids content. For example, the adhesive compositions can have a solids content from a low of about 5 wt %, about 10 wt %, or about 30 wt %, to a high of about 70 wt %, about 80 wt %, or about 95 wt %. In another example, the adhesive compositions can have a solids content greater than about 50 wt %, about 55 wt %, or about 70 wt %. In another example, the adhesive compositions can have a solids content from about 5 wt % to about 95 wt %, about 5 wt % to about 50 wt %, about 5 wt % to about 20 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 47 wt % to about 57 wt %, about 51 wt % to about 54 wt %, or about 50 wt % to about 60 wt %. The weight percent of the solids content of adhesive compositions can be based on the total weight of the adhesive composition or based on the total weight of the one or more styrene-butadiene rubbers latexes, one or more tackifier agents, one or more additives, and water.

The adhesive compositions can be used in a wide variety of products. For example, the products for the adhesive composition can be include, but are not limited to: coatings, drilling fluids, electrode binders for lithium-ion batteries, and polymer modifiers for asphalt emulsions. In another example, the products for the styrene-butadiene rubber latexes and/or coagulated latex (solid phase) can include, but are not limited to: tires, industrial hoses, flooring, shoe soles, chewing gum base, and belts.

### Examples

To provide a better understanding of the foregoing discussion, the following non-limiting examples are offered. Although the examples can be directed to specific embodiments, they are not to be viewed as limiting the invention in any specific respect.

As previously mentioned, the method making a latex can include the preparation of a polystyrene seed and then two or more rounds of hot emulsion reactions to generate a hot emulsion styrene butadiene rubber latex with solids content of 50% or greater. The polystyrene seed was prepared by contacting the following reagents: deionized water (1000 g), DOWFAX2A1 (15 g), sodium bicarbonate (11 g), Sulfole-120 (t-dodecyl mercaptan) (0.015 g), styrene (150 g), potassium persulfate, 7 wt % in deionized water (21.7 g), sodium metabisulfite (5 g), t-butylhydroperoxide (BHP) 10 wt % in deionized water, (0.7 g), and sodium hydrogen methane sulfamic acid, 7 wt % in deionized water (10 g).

The procedure utilized a 3.5 liter continuously stirred glass reactor with an internal temperature control system. Deionized water was added to the reactor followed by purging with nitrogen to remove air. Then, the sodium bicarbonate, DOWFAX2A1, and t-dodecyl mercaptan were added, and the system was again purged with nitrogen.

The reactor temperature was set to 50° C. and then padded with 30 psig of nitrogen. Then, the agitation speed was set to 220 rpm using the stirrer. Once the reactor reached set point temperature, the styrene was dosed into the reactor in 50 mL increments at a rate of 10 mL/minute. Once styrene addition was complete, the reactor temperature was raised to 75° C. Potassium persulfate was then added as a single dose and allowed to stir for 5 minutes. Sodium metabisulfite was started at a flow rate of 0.04 mL/minute and the reactor temperature raised to 80° C. After addition of sodium metabisulfite the reactor temperature was increased to 85° C. The reaction was allowed to proceed for 45 minutes, after which the reactor temperature was reduced to 54° C. followed by injection of t-butylhydroperoxide (BHP) (single portion) and addition of sodium hydrogen methane sulfamic acid solution at 0.3 mL/minute. The reactor temperature was reduced to 30° C. and the product removed from the reactor. A polystyrene latex having 14.4 weight percent solids with particle size of 45.95 nm was obtained, which acts as the polystyrene seed for the second segment of the reaction.

Next, the polystyrene seed is polymerized in a pressure reactor one or more times to generate a hot emulsion styrene butadiene rubber latex of desired solids content. The first styrene butadiene rubber latex was prepared by contacting the following reagents: polystyrene (12.17 g), DOWFAX2A1 (0.13 g), sodium bicarbonate (0.11 g), Sulfole-120 (t-dodecyl mercaptan) (0.011 g), styrene (2.92 g), potassium persulfate, 7 wt % in deionized water (0.71 g), sodium metabisulfite (0.594 g), t-butylhydroperoxide, 10 wt % in deionized water, (0.26 g), sodium hydrogen methane sulfamic acid, 7 wt % in deionized water, (0.26 g), SB-61 (0.61 g), and 1,3-butadiene (1 Ig).

In the first reaction, a 60 mL pressure reactor containing a magnetic stirrer, temperature probe and pressure monitor was set up in a temperature-controlled bath. All the reagents except the 1,3-butadiene were charged into the reactor at 25° C., which was then nitrogen purged to remove air. The pH was checked to determine the alkalinity of the mixture. The agitation for the reactor was set to over 1,000 rpm employing the magnetic stirrer. The specified quantity of 1,3-butadiene was charged into the reactor, the reactor temperature set to 50° C., and the reactor was padded with 80 psig nitrogen to minimize butadiene reflux. The reaction proceeded for 23 hours until polymerization was stopped, and the product was removed and analyzed. The resulting product was a styrene butadiene rubber latex having 46 weight percent solids, pH=9.0, and particle size of 141 nm. This styrene butadiene rubber latex acts as a seed for further polymerization.

TABLE 1
Results of Single Stage Styrene Butadiene Rubber Latex Synthesis at Low pH

| | | | Run Time, | Particle | % | % Styrene | % Styrene |
|---|---|---|---|---|---|---|---|
| Run | Stage | pH | h | size, nm | Solids | (Bound) | (residual) |
| I | 1 | <4.0 | 20 | 121 | 40 | N/A | N/A |

The second reaction runs similarly to the first reaction, except the styrene butadiene rubber latex generated from stage one acts as the seed. 11.99 g of the styrene butadiene rubber latex generated from stage one was charged into the reactor. The same polymerization steps from the first reaction were applied to the seed, and the reaction was allowed to proceed for another 23 hours after the 1,3-butadiene was charged into the reactor. After 23 hours the product was removed from the reactor and analyzed. The product was determined to be styrene butadiene rubber latex having 53 weight percent solids, pH=9.0, and particle size of 356 nm. The styrene butadiene rubber latex had bound styrene of 32 wt % and residual styrene of 1.5 wt %.

TABLE 2
Two-Stage Styrene Butadiene Rubber Latex Synthesis at High pH

| | | | | | | % | % |
|---|---|---|---|---|---|---|---|
| | | | Run | Particle size, | | Styrene | Styrene |
| Run | Stage | pH | Time, hrs | nm | % Solids | (Bound) | (residual) |
| I | 1 | 9.0 | 23 | 141 | 46.40 | 32 | N/A |
| I | 2 | 9.0 | 23 | 356 | 53.14 | 32 | 1.5 |
| II | 1 | 9.0 | 23 | 210 | 46.34 | 25 | 1.22 |
| II | 2 | 9.0 | 23 | 425 | 52.20 | 31 | 1.6 |

In the examples, the first reaction yielded a lower solids content styrene butadiene rubber latex, than the second reaction, where the latex is further polymerized to create a styrene butadiene rubber latex with a higher solids content (over 50 wt %).

Additional examples of two-stage styrene butadiene rubber latexes were made to measure percent solids, density, viscosity, particles size (P.S.), and Zeta potential. The results are shown in Table 3.

TABLE 3
Two-Stage Styrene Butadiene Rubber Latex Synthesis

| | | | | | | | Zeta |
|---|---|---|---|---|---|---|---|
| Sample | | | % | Den. | | P.S. | Pot |
| No | Stage | Product | Solids | g/mL | Vis. cP | nm | mV |
| 1 | 2 | SBR | 48.68 | 0.999 | 10.00 | 150.84 | −56.40 |
| 2 | 2 | SBR | 47.37 | 1.051 | 8.50 | 138.67 | −41.20 |
| 3 | 2 | SBR | 52.17 | 1.011 | 14.50 | 164.65 | −61.50 |
| 4 | 2 | SBR | 57.09 | 1.012 | 65.50 | 200.1 | −50.40 |
| 5 | 2 | SBR | 47.95 | 1.003 | 11.00 | 153.36 | −51.70 |
| 6 | 1 | SBR | 51.3 | 1.006 | 2.00 | 111.97 | −49.30 |
| 7 | 2 | SBR | 47.06 | 1.004 | 12.50 | 152.61 | −56.10 |
| 8 | 2 | SBR | 51.11 | 1.00 | 16.50 | 196.69 | −55.50 |
| 9 | 2 | SBR | 49.12 | 1.013 | 7.50 | 159.04 | −53.50 |
| 10 | 1 | SBR | 42.39 | 1.01 | 5.00 | 145.78 | −51.70 |
| 11 | 1 | SBR | 35.03 | 1.019 | 1.50 | 107.62 | −65.30 |
| 12 | 2 | SBR | 42.55 | 1.032 | 3.00 | 128.03 | −56.50 |
| 13 | 1 | SBR | 30.56 | 1.02 | 1.00 | 125.16 | −54.60 |
| 14 | 2 | SBR | 40.89 | 1.034 | 3.00 | 159.51 | −64.30 |
| 15 | 1 | SBR | 46.93 | 1.013 | 15.00 | 128.9 | −60.80 |
| 16 | 1 | SBR | 36.43 | 1.022 | 2.50 | 150.9 | −74.00 |
| 17 | 2 | SBR | 49.17 | 1.009 | 36.50 | 159.57 | −55.40 |
| 18 | 1 | SBR | 39.02 | 1.016 | 3.00 | 151.22 | −52.00 |
| 19 | 2 | SBR | 47.32 | 1.02 | 10.00 | 142.83 | −64.40 |
| 20 | 2 | SBR | 48.16 | 1.01 | 16.00 | 157.01 | −57.00 |
| 21 | 2 | SBR | 47.67 | 0.998 | 14.50 | 142.99 | −78.10 |
| 22 | 2 | SBR | 48.8 | 1.022 | 24.00 | 170.89 | −59.00 |
| 23 | 1 | SBR | 38.1 | 1.022 | 4.00 | 133.24 | −55.70 |
| 24 | 1 | SBR | 37.2 | 1.025 | 3.50 | 115.49 | −55.40 |
| 25 | 0 | Pstyrene | 12.8 | 1.0045 | <5.00 | 80 | −50.20 |
| 26 | 0 | Pstyrene | 17.8 | 1.0095 | <5.00 | 73.4 | −62.90 |
| 27 | 0 | Pstyrene | 13 | 0.999 | <5.00 | 94.75 | −56.10 |
| 28 | 0 | Pstyrene | 12.15 | 0.987 | <5.00 | 94.24 | −60.70 |
| 29 | 0 | Pstyrene | 12.73 | 1.028 | <5.00 | 101.76 | −53.00 |
| 30 | 0 | Pstyrene | 13.72 | | <5.00 | 90.19 | −58.50 |

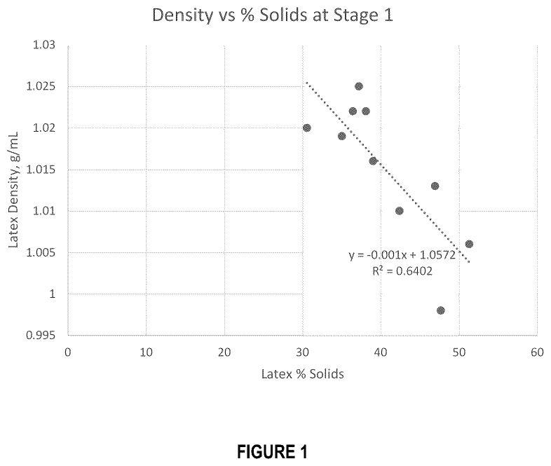

Table 4 shows the percent solids, density, viscosity, particles size, and Zeta potential for the styrene butadiene rubber latex at stage 1. FIG. 1 shows density as a function of percent solids content for the styrene butadiene rubber latex at stage 1.

TABLE 4
Density as a Function of Percent Solids Content at Stage 1

| Sample | | | | Den. | | | Zeta |
|---|---|---|---|---|---|---|---|
| No | Stage | Product | % Solids | g/mL | Vis. cP | P.S. nm | Pot mV |
| 6 | 1 | SBR | 51.3 | 1.006 | 2.00 | 111.97 | −49.30 |
| 10 | 1 | SBR | 42.39 | 1.01 | 5.00 | 145.78 | −51.70 |
| 11 | 1 | SBR | 35.03 | 1.019 | 1.50 | 107.62 | −65.30 |
| 13 | 1 | SBR | 30.56 | 1.02 | 1.00 | 125.16 | −54.60 |
| 15 | 1 | SBR | 46.93 | 1.013 | 15.00 | 128.9 | −60.80 |
| 16 | 1 | SBR | 36.43 | 1.022 | 2.50 | 150.9 | −74.00 |
| 18 | 1 | SBR | 39.02 | 1.016 | 3.00 | 151.22 | −52.00 |
| 23 | 1 | SBR | 38.1 | 1.022 | 4.00 | 133.24 | −55.70 |
| 24 | 1 | SBR | 37.2 | 1.025 | 3.50 | 115.49 | −55.40 |
| 21 | 1 | SBR | 47.67 | 0.998 | 14.50 | 142.99 | −78.10 |
| Average | | | 40.46 | 1.02 | 5.2 | 131.33 | −59.69 |
| Range | | | 30.6- | | 2.0-15 | 107.6- | −49.3- |
| | | | 51.3 | | | 151.2 | (−78.1) |

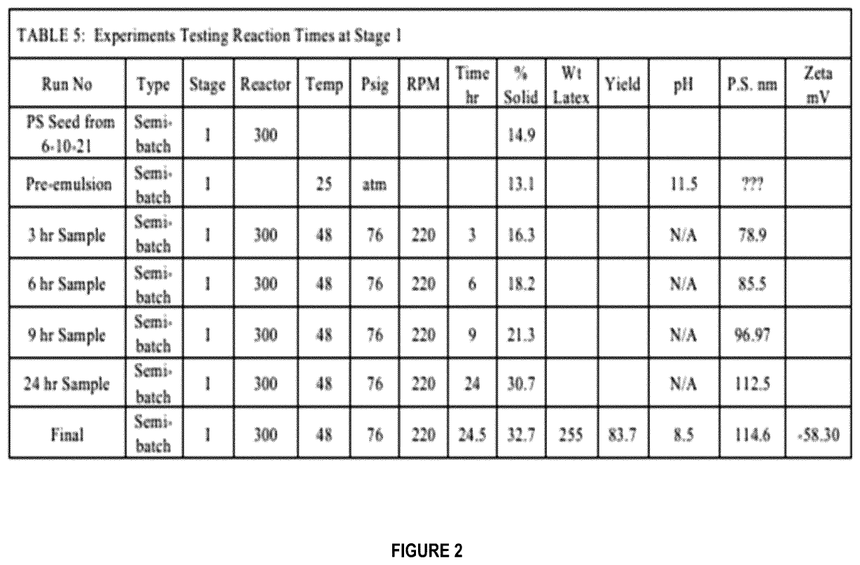

Experiments testing the reaction times for the synthesis of styrene butadiene rubber latex at stage 1 were performed. FIG. 2 shows Table 5, which are the changes in properties of styrene butadiene rubber latexes at stage 1. The styrene butadiene rubber latexes of Table 5 were made in semi-batch syntheses in which additions of the 1,3-butadiene were added periodically.

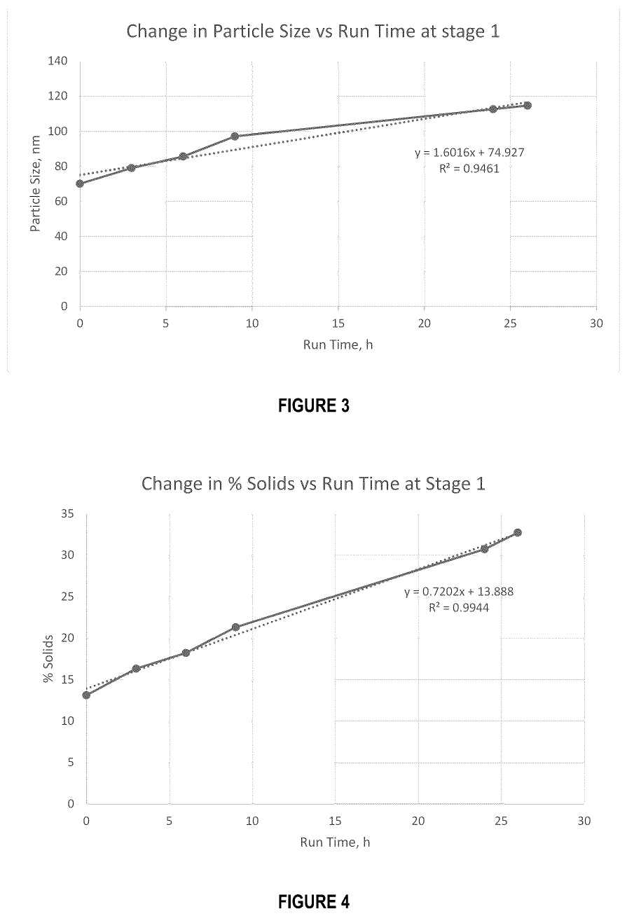

Table 6 show the change in percent solids and particle size as a function of reaction time for a styrene butadiene rubber latex at stage 1. FIGS. 3 and 4 are graphs of Table 6.

TABLE 6
Percent Solids and Particle Size as a
Function of Reaction Time at Stage 1

| Time, h | % Solids | P.S. |
|---|---|---|
| 0 | 13.1 | 70 |
| 3 | 16.3 | 78.9 |
| 6 | 18.2 | 85.5 |
| 9 | 21.3 | 96.97 |
| 24 | 30.7 | 112.5 |
| 26 | 32.7 | 114.6 |

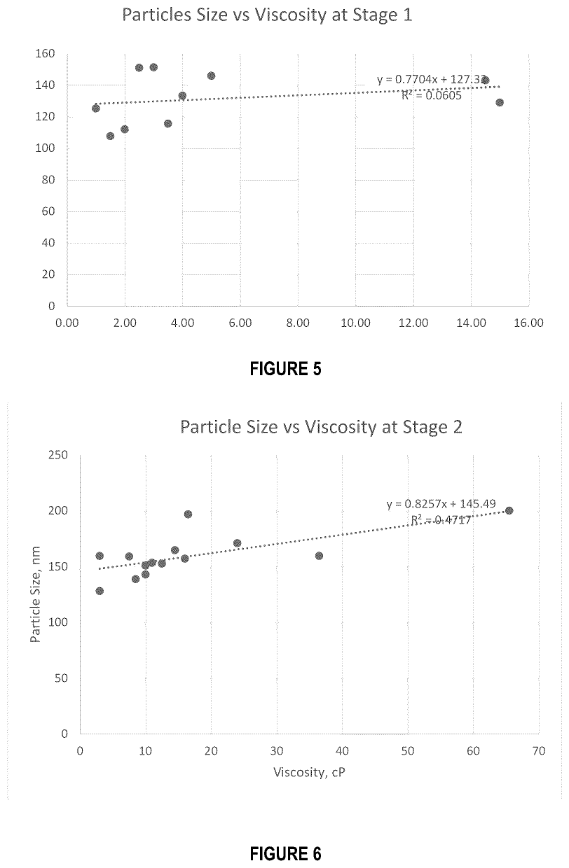

Table 7 shows viscosity as a function of particles size for a styrene butadiene rubber latex. FIG. 5 is a graph of Table 7.

TABLE 7
Viscosity as a Function of Particles Size

| Vis. cP | P.S. nm |
|---|---|
| 2.00 | 111.97 |
| 5.00 | 145.78 |
| 1.50 | 107.62 |
| 1.00 | 125.16 |
| 15.00 | 128.9 |
| 2.50 | 150.9 |
| 3.00 | 151.22 |
| 4.00 | 133.24 |
| 3.50 | 115.49 |
| 14.50 | 142.99 |

Table 8 shows the percent solids, density, viscosity, particles size, and Zeta potential for the styrene butadiene rubber latex at stage 2. FIG. 6 shows the particles size as a function of viscosity for the styrene butadiene rubber latex at stage 2.

TABLE 8
Properties of Styrene Butadiene Rubber Latex at Stage 2

| Sample | | | % | Den. | | P.S. | Zeta Pot |
|---|---|---|---|---|---|---|---|
| No | Stage | Product | Solids | g/mL | Vis. cP | nm | mV |
| 1 | 2 | SBR | 48.68 | 0.999 | 10.00 | 150.84 | −56.40 |
| 2 | 2 | SBR | 47.37 | 1.051 | 8.50 | 138.67 | −41.20 |
| 3 | 2 | SBR | 52.17 | 1.011 | 14.50 | 164.65 | −61.50 |
| 4 | 2 | SBR | 57.09 | 1.012 | 65.50 | 200.1 | −50.40 |
| 5 | 2 | SBR | 47.95 | 1.003 | 11.00 | 153.36 | −51.70 |
| 7 | 2 | SBR | 47.06 | 1.004 | 12.50 | 152.61 | −56.10 |
| 8 | 2 | SBR | 51.11 | 1.00 | 16.50 | 196.69 | −55.50 |
| 9 | 2 | SBR | 49.12 | 1.013 | 7.50 | 159.04 | −53.50 |
| 12 | 2 | SBR | 42.55 | 1.032 | 3.00 | 128.03 | −56.50 |
| 14 | 2 | SBR | 40.89 | 1.034 | 3.00 | 159.51 | −64.30 |
| 17 | 2 | SBR | 49.17 | 1.009 | 36.50 | 159.57 | −55.40 |
| 19 | 2 | SBR | 47.32 | 1.02 | 10.00 | 142.83 | −64.40 |
| 20 | 2 | SBR | 48.16 | 1.01 | 16.00 | 157.01 | −57.00 |
| 22 | 2 | SBR | 48.8 | 1.022 | 24.00 | 170.89 | −59.00 |
| Average | | | 48.39 | 1.015 | 17.04 | 159.56 | −55.92 |
| Range | | | 47-57 | 0.999-1.034 | 3.0-65.5 | 128-200 | −41-(−64) |

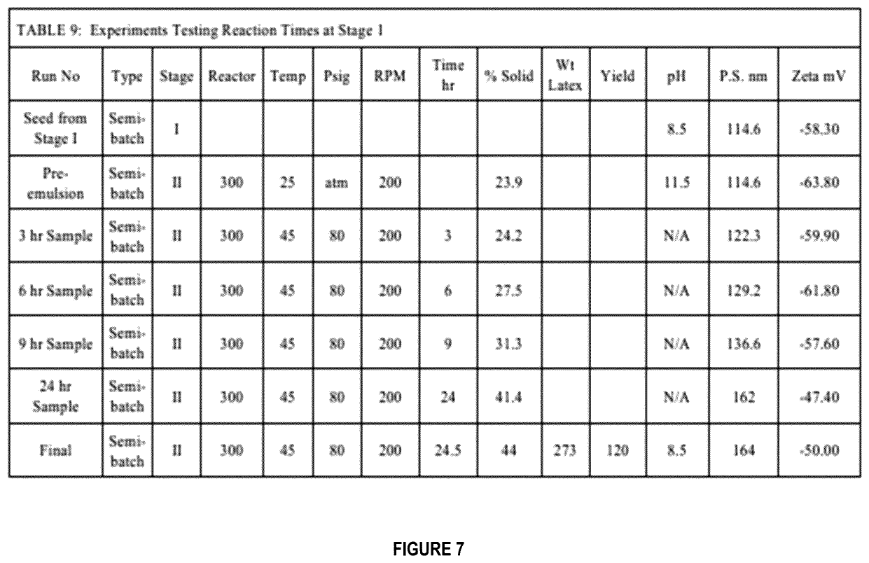

Experiments testing the reaction times for the synthesis of styrene butadiene rubber latex at stage 2 were performed. FIG. 7 shows Table 9, which are the changes in properties of styrene butadiene rubber latexes at stage 2. The styrene butadiene rubber latexes of Table 9 were made in semi-batch syntheses in which additions of the 1,3-butadiene were added periodically.

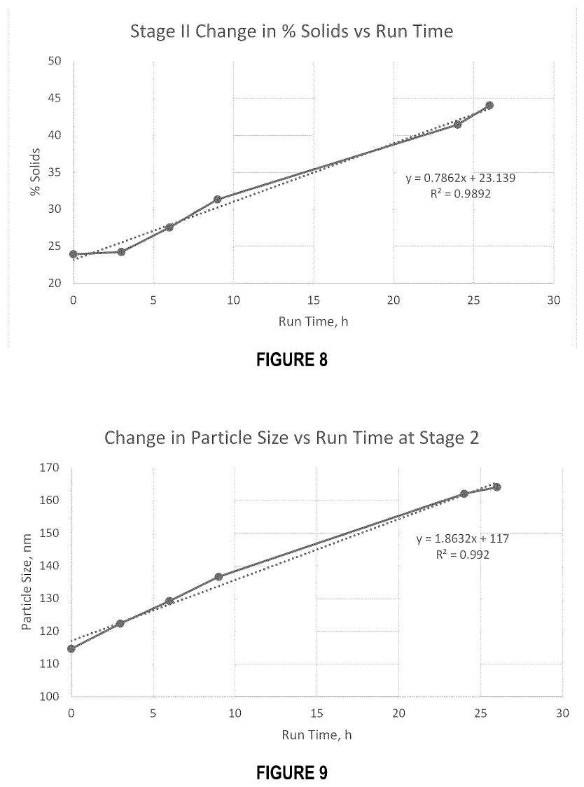

Table 10 shows the change in percent solids and particle size as a function of reaction time for a styrene butadiene rubber latex at stage 2. FIGS. 8 and 9 are graphs of Table 10.

TABLE 10
Percent Solids and Particle Size as a
Function of Reaction Time at Stage 2

| Time, h | % Solids | P.S. nm |
|---|---|---|
| 0 | 23.9 | 114.6 |
| 3 | 24.2 | 122.3 |
| 6 | 27.5 | 129.2 |
| 9 | 31.3 | 136.6 |
| 24 | 41.4 | 162 |
| 26 | 44 | 164 |

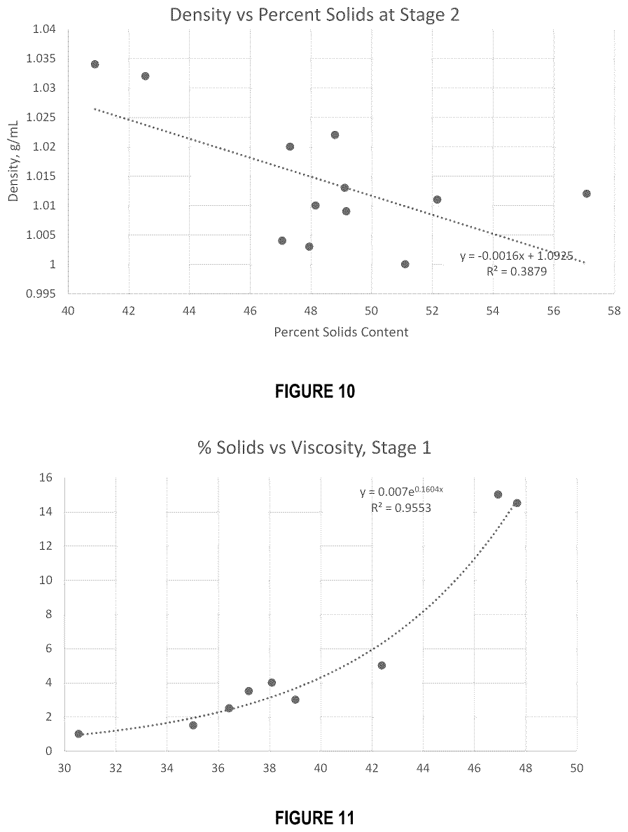

Table 11 shows density as a function of percent solids for a styrene butadiene rubber latex. FIG. 10 is a graph of Table 11.

TABLE 11
Density as a Function of Percent Solids at Stage 2

| % Solids | Den. g/mL |
|---|---|
| 52.17 | 1.011 |
| 57.09 | 1.012 |
| 47.95 | 1.003 |
| 47.06 | 1.004 |
| 51.11 | 1 |
| 49.12 | 1.013 |
| 42.55 | 1.032 |
| 40.89 | 1.034 |
| 49.17 | 1.009 |
| 47.32 | 1.02 |
| 48.16 | 1.01 |
| 48.8 | 1.022 |

Table 12 is the viscosity as a function of percent solids content for the styrene butadiene rubber latex at stage 1. FIG. 11 is a graph of Table 12.

TABLE 12
Viscosity as a Function of percent Solids at Stage 1

| % Solids | Vis. cP |
|---|---|
| 42.39 | 5.00 |
| 35.03 | 1.50 |
| 30.56 | 1.00 |
| 46.93 | 15.00 |
| 36.43 | 2.50 |
| 39.02 | 3.00 |
| 38.1 | 4.00 |
| 37.2 | 3.50 |
| 47.67 | 14.50 |

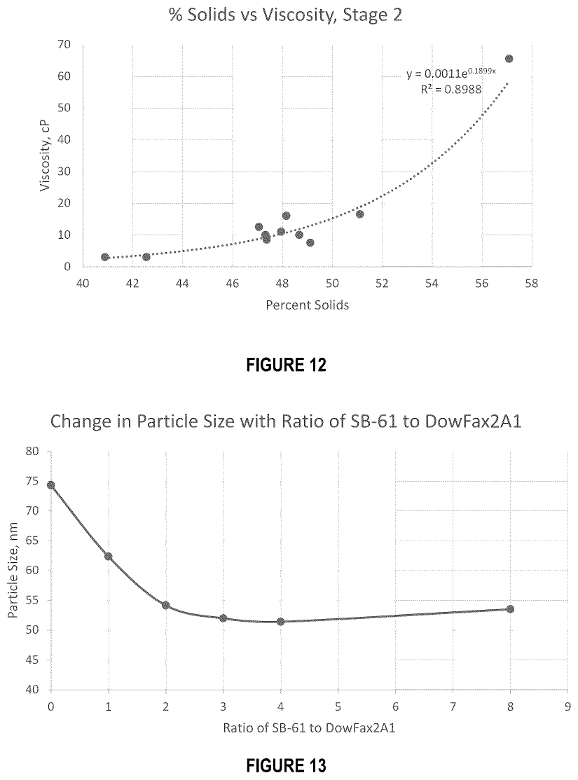

Table 13 is the viscosity as a function of percent solids content for the styrene butadiene rubber latex at stage 2. FIG. 12 is a graph of Table 13.

TABLE 13
Viscosity as a Function of percent Solids at Stage 2

| % Solids | Vis. cP |
|---|---|
| 48.68 | 10.00 |
| 47.37 | 8.50 |
| 57.09 | 65.50 |
| 47.95 | 11.00 |
| 47.06 | 12.50 |
| 51.11 | 16.50 |
| 49.12 | 7.50 |
| 42.55 | 3.00 |
| 40.89 | 3.00 |
| 47.32 | 10.00 |
| 48.16 | 16.00 |

Table 14 shows summarizes the measured properties for the styrene butadiene rubber latex at stages 1 and 2.

TABLE 14
Properties for the Styrene Butadiene Rubber Latex at Stage 1 and 2

| Parameter | Stage 1 | Stage 2 |
|---|---|---|
| % Solids, Avg | 40 | 48.4 |
| % Solids Range | 30-51 | 47-57 |
| Density, Avg g/mL | 1.015 | 1.016 |
| Density, Range | 0.998-1.025 | 0.999-1.034 |
| Viscosity, Avg cP | 5.2 | 17.04 |
| Viscosity Range | 2.0-15 | 3.0-65.5 |
| Particle Size, Avg nm | 131 | 159.6 |
| Particle Size, Range | 107-151 | 128-200 |
| Zeta Potential, Avg mV | 59.7 | −55.9 |
| Zeta Potential Range | −49.3-(−78) | −41-(−64) |

Further experiments were performed to show the impact of mixing surfactants on polystyrene latex particle size. Two surfactants were tested: DowFax2A1 (49.7 weight percent) from Dow Chemical and HeiQ SB-61 (52.2 weight percent) from Chemtech. Comparatives were made by running each surfactant separately under identical experimental conditions. The results showed that DowFax2A1 produced latex particles having an average size of 74.28 nm and the SB-61 produced latex particles having an average size of 66.96 nm. Subsequent polymerizations were conducted under the same conditions but with different ratios of SB-61 to DowFax2A1. Table 15 shows the results surfactant ratios on the particles size for the styrene butadiene rubber latex. FIG. 13 is a graph of Table 15.

TABLE 15
Impact of Surfactant Ratio on Latex Particle Size

| | Ratio (Vol.) | Particle size, |
|---|---|---|
| Run No. | SB-61:DowFax2A1 | nm |
| 1 | 0:1 | 74.28 |
| 2 | 1:1 | 62.32 |
| 3 | 2:1 | 54.11 |
| 4 | 3:1 | 51.95 |
| 5 | 4:1 | 51.38 |
| 6 (comparative) | 1:0 | 66.96 |
| 7 | 8:1 | 53.47 |

Results suggest that as the level of SB-61 increases (up to 4:1), the latex particle size decreases. At higher levels of SB-61 (8:1) the particle size starts to increase.

One of ordinary skill in the art will readily appreciate that alternative but functionally equivalent components, materials, designs, and equipment can be used. The inclusion of additional elements can be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present invention is intended to embrace all such alternatives, modifications, and variations as fall within the scope of the claims, together with all equivalents thereof.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art. Unless otherwise indicated, all numbers expressing feature sizes, amounts, and physical properties used in the specification and claims are to be understood as being modified in all instances by the term “about.” The term “about” is defined to be ±2% of the modified value.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components illustrated above should not be understood as requiring such separation, and it should be understood that the described program components and systems can generally be integrated together in a single software product or packaged into multiple software products.

All patents, patent applications, provisional applications, and publications referred to or cited herein are incorporated by reference in their entirety, including all figures and tables, to the extent they are not inconsistent with the explicit teachings of this specification.

What is claimed is:

1. A method for making styrene butadiene rubber latex comprising:
mixing a seed, a styrene, an initiator, a base, one or more surfactants, and a solvent to make a first mixture, wherein the first mixture has pH from about 3.0 to about 12.0;
adding a first portion of 1,3-butadiene to the first mixture to make a first reaction mixture;
heating the first reaction mixture to a temperature above 40° C. for a first reaction time from about 10 hours to about 24 hours to make a first styrene butadiene rubber latex, wherein the first styrene butadiene rubber latex has an average Zeta potential from about −49.3 mV to about −78 mV;
mixing the first styrene butadiene rubber latex, a styrene, a base, an initiator, one or more surfactants, and a solvent to make a second mixture, wherein the second emulsion has a pH from about 4.0 to about 12.0;
adding a second portion of 1,3-butadiene to the second mixture to make a second reaction mixture; and
heating the second reaction mixture to a temperature above 40° C. for a second reaction time of from about 10 to about 24 hours to make a second styrene butadiene rubber latex, wherein the second styrene butadiene rubber latex has a solids content greater than the first styrene butadiene rubber latex, wherein the second styrene butadiene rubber latex has an average Zeta potential from about −41 mV to about −64 mV.

2. The method of claim 1, wherein the second styrene butadiene rubber latex has a solids content of greater than 45 wt %.

3. The method of claim 1, wherein the seed is selected from group comprising: polystyrene, natural rubber, styrene-butadiene, nitrile rubber, and polybutadiene.

4. The method of claim 1, and wherein the one or more surfactants are selected from a list comprising: alkyldiphenyloxide disulfonate; benzene, 1,1′-oxybis-, tetrapropylene sulfonate; sodium 4-(4-dodecoxysulfonylphenoxy)benzenesulfonate; alkyl mercaptan; ethoxylated amines; ethoxylated long-chain alcohols; polyglucosides; alkyl ammonium bromides; alkyl sulfonates; alkoxylated sulfates; alkyl ether sulfates; alkyl ester sulfonates; alpha olefin sulfonates; linear alkyl benzene sulfonates; branched alkyl benzene sulfonates; linear dodecylbenzene sulfonates; branched dodecylbenzene sulfonates; alkyl benzene sulfonic acids; dodecylbenzene sulfonic acid; sulfosuccinates; ethoxylated sulfated alcohols; alcohol sulfonates; ethoxylated alcohol sulfonates; propoxylated alcohol sulfonates; alcohol ether sulfates; ethoxylated alcohol ether sulfates; propoxylated alcohol sulfonates; sodium xylene sulfonate; sodium dodecyl diphenyl ether disulfonate; sulfated nonyl phenols; ethoxylated sulfated nonyl phenols; propoxylated sulfated nonyl phenols; sulfated octyl phenols; ethoxylated sulfated octyl phenols; propoxylated sulfated octyl phenols; sulfated dodecyl phenols; ethoxylated sulfated dodecyl phenols hydroxysultaines; propoxylated sulfated dodecyl phenols hydroxysultaines; ethoxylated dodecanol; alkyl ammonium bromides; cetyl trimethyl ammonium bromide; methyl sulfonate; heptyl sulfonate; decylbenzene sulfonate; dodecylbenzene sulfonate; cocoamidopropyl hydroxysultaine; lauramidopropyl hydroxysultaine; lauryl hydroxysultaine.

5. The method of claim 1, wherein the initiator is selected from a list comprising: potassium persulfate, cumene hydroperoxide, 2,2′-azobis[2-(2-imidazolin-2-yl)propane] dihydrochloride, tert-butyl hydroperoxide, di-tert-butyl peroxide, dicumyl peroxide, benzoyl peroxide, ammonium peroxodisulfate, dicyandiamide, cyclohexyl p-toluenesulfonate, (4-hydroxyphenyl)dimethylsulfonium hexafluorophosphate, diphenyl(methyl)sulfonium tetrafluoroborate, benzyl(4-hydroxyphenyl)methylsulfonium hexafluoroantimonate, (4-hydroxyphenyl)methyl(2-methylbenzyl)sulfonium hexafluoroantimonate, and triphenylsulfonium nonafluoro-1-butanesulfonate.

6. The method of claim 1, wherein the first styrene butadiene rubber latex has a styrene butadiene rubber with an average particle size from about 107 nm to about 151 nm.

7. The method of claim 1, wherein the second styrene butadiene rubber latex has a styrene butadiene rubber with an average particle size from about 128 nm to about 200 nm.

8. The method of claim 1, wherein the second styrene butadiene rubber latex has a solids content from about 47 wt % to about 57 wt %.

9. The method of claim 1, wherein the first reaction further comprising a chain transfer agent, wherein the chain transfer agent is selected from a list comprising: alkyl mercaptan, tert-dodecyl mercaptan, carbon tetrachloride, carbon tetrabromide, bromotrichloromethane, 4-methylbenzenethiol, isooctyl 3-mercaptopropionate, pentaphenylethane, and tert-nonyl mercaptan, 4,4′-thiobisbenzenethiol.

10. The method of claim 4, wherein the one or more surfactants comprises two surfactants.

11. The method of claim 4, wherein the two surfactants have a weight ratio from about 45 about 55 for the first surfactant to about 55 to about 45 for the second surfactant.

12. A styrene butadiene rubber latex composition made by a process comprising:
mixing a seed, a styrene, an initiator, a base, one or more surfactants, and a solvent to make a first mixture, wherein the first mixture has pH from about 3.0 to about 12.0;
adding a first portion of 1,3-butadiene to the first mixture to make a first reaction mixture;
heating the first reaction mixture to a temperature above 40° C. for a first reaction time from about 10 to about 24 hours to make a first styrene butadiene rubber latex, wherein the first styrene butadiene rubber latex has an average Zeta potential from about −49.3 mV to about −78 mV;
mixing the first styrene butadiene rubber latex, a styrene, a base, an initiator, one or more surfactants, and a solvent to make a second mixture, wherein the second emulsion has a pH from about 4.0 to about 12.0;
adding a second portion of 1,3-butadiene to the second mixture to make a second reaction mixture; and
heating the second reaction mixture to a temperature above 40° C. for a second reaction time of from about 10 hours to about 24 hours to make a second styrene butadiene rubber latex, wherein the second styrene butadiene rubber latex has a solids content greater than the first styrene butadiene rubber latex, wherein the second styrene butadiene rubber latex has an average Zeta potential from about −41 mV to about −64 mV.

13. The styrene butadiene rubber latex composition of claim 12, wherein the first styrene butadiene rubber latex has a styrene butadiene rubber with an average particle size from about 107 nm to about 151 nm.

14. The styrene butadiene rubber latex composition of claim 12, wherein the second styrene butadiene rubber latex has a styrene butadiene rubber with an average particle size from about 128 nm to about 200 nm.

15. The styrene butadiene rubber latex composition of claim 12, wherein the second styrene butadiene rubber latex has a solids content from about 47 wt % to about 57 wt %.

16. The method of claim 12, and wherein the one or more surfactants are selected from a list comprising: alkyldiphenyloxide disulfonate; benzene, 1,1′-oxybis-, tetrapropylene sulfonate; sodium 4-(4-dodecoxysulfonylphenoxy)benzenesulfonate; alkyl mercaptan; ethoxylated amines; ethoxylated long-chain alcohols; polyglucosides; alkyl ammonium bromides; alkyl sulfonates; alkoxylated sulfates; alkyl ether sulfates; alkyl ester sulfonates; alpha olefin sulfonates; linear alkyl benzene sulfonates; branched alkyl benzene sulfonates; linear dodecylbenzene sulfonates; branched dodecylbenzene sulfonates; alkyl benzene sulfonic acids; dodecylbenzene sulfonic acid; sulfosuccinates; ethoxylated sulfated alcohols; alcohol sulfonates; ethoxylated alcohol sulfonates; propoxylated alcohol sulfonates; alcohol ether sulfates; ethoxylated alcohol ether sulfates; propoxylated alcohol sulfonates; sodium xylene sulfonate; sodium dodecyl diphenyl ether disulfonate; sulfated nonyl phenols; ethoxylated sulfated nonyl phenols; propoxylated sulfated nonyl phenols; sulfated octyl phenols; ethoxylated sulfated octyl phenols; propoxylated sulfated octyl phenols; sulfated dodecyl phenols; ethoxylated sulfated dodecyl phenols hydroxysultaines; propoxylated sulfated dodecyl phenols hydroxysultaines; ethoxylated dodecanol; alkyl ammonium bromides; cetyl trimethyl ammonium bromide; methyl sulfonate; heptyl sulfonate; decylbenzene sulfonate; dodecylbenzene sulfonate; cocoamidopropyl hydroxysultaine; lauramidopropyl hydroxysultaine; lauryl hydroxysultaine.

17. The method of claim 16, wherein the one or more surfactants comprises two surfactants.

18. The method of claim 16, wherein the two surfactants have a weight ratio from about 45 about 55 for the first surfactant to about 55 to about 45 for the second surfactant.

19. A styrene butadiene rubber latex composition comprising:
a styrene butadiene rubber latex, wherein the styrene butadiene rubber latex has a weight ratio of styrene to butadiene from about 20 to about 30 of styrene to about 80 to about 70 of butadiene, wherein the styrene butadiene rubber has an average particle size from about 128 nm to about 200 nm, wherein the styrene butadiene rubber latex has a solids content from greater than about 45 wt %, wherein the styrene butadiene rubber latex has a density from about 0.999 g/mL to about 1.034 g/mL, wherein the styrene butadiene rubber latex has an average Zeta potential from about −41 mV to about −64 Mv, and wherein the styrene butadiene rubber latex has a viscosity from about 3.0 cP to about 65.5 cP.

20. A styrene butadiene rubber latex composition of claim 19, wherein the second styrene butadiene rubber latex has a solids content about 47 wt % to about 57 wt %,
